(19) United States
(12) Patent Application Publication
(10) Pub. No.: US 2003/0097321 A1
(43) Pub. Date: May 22, 2003

(54) Method and system for concentratedly managing funds among enterprises

(76) Inventors: Masakazu Arikawa, Kanagawa (JP); Hiroshi Kurihara, Kanagawa (JP); Takehiro Yagi, Kanagawa (JP); Nobuo Tanabe, Tokyo (JP)

Correspondence Address: William S Frommer, Frommer Lawrence & Haug, 745 Fifth Avenue, New York, NY, 10151, US

(21) Appl. No.: 10/181,501

(22) PCT Filed: Nov. 22, 2001
(86) PCT No.: PCT/JP01/10245

(51) Int. Cl. G06F 17/60

(52) U.S. Cl. 705/35

(57) ABSTRACT

There are provided a method and system for intra-company group centralized management of funds, capable of foreign exchange control. The breakdown of funds concentrated to a funds concentration account to which the funds of companies belonging to a group can be known from a received deposits table sectioned for each of the companies in the group. In case the funds are managed in each currency unit by the company, each section of the received deposits table is sub-sectioned for each of the companies. The centralized funds management system has means for calculating the currency unit of the funds recorded in the received deposits table from one to another. With this system, the company can convert its own fund from an amount in one currency unit into a one in another currency unit, and also convert proceeds received in a foreign currency into a money in the currency of its own country.

### TECHNICAL FIELD

The present invention generally relates to a method and system for intra-company group centralized management of funds, and more particularly to an intra-company group funds concentration system capable of dealing with currencies of multiple countries, exchange dealing apparatus and method, computer-readable storage medium having exchange dealer program stored therein, currency change server computer, currency change method, currency change server program, currency change client computer, and a currency change client program.

### BACKGROUND ART

The conventional funds concentration systems have adopted a method in which funds of front and branch offices of a company are concentrated to one account and the breakdown of the funds of the front and branch offices is managed with reference to a data base or the like. This method needs no transfer of funds between the accounts of the front and branch offices for clearing up an obligation between the offices and no crediting of funds into the account of a branch office or the like in which is short of the funds, which permits to cut service charges for payment into accounts and reduce the number of transactions such as payment or the like.

The analysis of the business between companies belonging to a group (or group of companies) has proved that the net transfer of funds actually accumulated in the account of each company is not so frequent but there are made many transactions for mutual payment of funds and settlement amount into the accounts of the companies. That is, in clearing up an obligation between the companies in a group, an subtraction is made between amounts of money to be paid from a company to another company or vice versa, for example, and the subtraction result, namely, a difference between the money amounts is paid to the account of one of the companies that should receive it. Thus, the actual transfer of funds is not so frequent but there occur large service charges for payment into accounts and costs for transactions. By concentrating the funds of the companies in the group to one account (of the group of companies), it will be possible to considerably cut the costs for the settlement of an obligation between the companies.

As an example of such a company funds concentration system, the method and system for computer-aided integrated administration of funds and financial information of multiple companies are known from the disclosure in the Japanese Published Unexamined Application No. 154194 of 1999.

In the above system, multiple companies are grouped and their funds are concentrated to one account. A virtual account of each of the companies is set up based on a data base, and the breakdown of funds in the account of each company is ascertained based on the balance on the virtual account. By updating the data about the balance on the virtual account, funds are virtually transferred between the companies in the group without actual transfer of any funds. Also, proceeds and amounts due resulted from trading of each company with companies not belonging to the group are paid into or out of the funds concentration account and the balance on the account of each company is updated. Also, each company can borrow money from the funds concentration account by manipulating the data about its own virtual account.

These days, however, many companies have developed their business globally over the borders through the export and import, and thus each of the companies has to deal with currencies of multiple countries. Also, the company developing the global business has overseas affiliated companies, branch offices and factories, and thus has to make global financial management, including financing, of such affiliated companies, branch offices and factories.

After the foreign exchange market had shifted to the free floating exchange rate system, the values of the currencies are always varying. Therefore, the companies having to deal with such foreign currencies are always at risk to suffer a loss due to a fluctuation in foreign exchange.

For example, a money for a merchandise sold (accounts receivable) is normally collected by the seller from the buyer in a predetermined number of days such as 30 days, 60 days or the like. In this case, if the yen, for example, has been stronger after the sale of the merchandise in dollars until the accounts receivable are paid to the seller, the seller will practically receive a money decreased in value.

In these circumstances, the finance departments or the like of companies are making financial management, including foreign exchange control, individually. These finance departments make investments in derivatives such as futures, swaps, options and the like to hedge against an exchange risk.

However, the persons in charge of the recent foreign exchange business should have extremely profound knowledge of the exchange and many practical experiences in the field of exchange or deep knowledge of the financial engineering, and there are currently found differences in financial skill from one company to another.

In these circumstances, quality financial services should be made available to each of the grouped companies by building up a funds concentration system capable of collectively acting on behalf of the companies belonging to the group for payment and settlement and hedging the exchange risk.

Also, the above funds concentration systems are advantageous for each of the companies in a group that the charges for money transfer services can be cut. However, the company has to make a request to the funds concentration system once for payment of a money which is to be paid to a company outside the company group, without any direct payment request to its bank. If the request for the alternative payment is complicated, each of the grouped companies cannot enjoy any large advantages even with the participation in the funds concentration system in some cases.

Currently, there are many kinds of currencies used in international trades over the world and there are many kinds of pairs of currencies (currency pairs) between which currency change is to be made at the customer's request. It is a big burden to the traders to hedge such many kinds of currency pairs against the exchange risk.

Further, even if the currency unit of a money to be paid by the company, a member of the funds concentration system to a customer is the same as that of a money to be paid by the customer to its customer, the money to be received by the customer is converted or changed once in a currency unit used in the accounting in the customer, the currency-changed money is converted into its original currency unit and paid to the customer as the case may be.

### DISCLOSURE OF THE INVENTION

Accordingly, the present invention has an object to overcome the above-mentioned drawbacks of the prior art by providing an intra-company group funds concentration system capable of foreign exchange function, an exchange dealing apparatus and method, and a computer-readable storage medium having exchange dealing program stored therein.

The present invention has another object to provide an intra-company group funds concentration system capable of efficiently hedging exchange risk with many kinds of currency pairs, an exchange dealing apparatus and method, and an exchange dealing program.

The present invention has still another object to project a netting apparatus capable of netting while dealing with many kinds of currencies, a netting method, and a netting program.

The above object can be attained by providing a funds concentration system for pooling funds in different currency units of each of companies belonging to a group in a single funds concentration account for centralized management of the funds, the system including according to the present invention:

means for acquiring information on in-payment of a fund paid into the funds concentration account;

means for acquiring information on out-payment of a fund paid from the funds concentration account by a member company of the company group;

a received deposits table having stored in a section thereof a breakdown of the fund balance on the funds concentration account for each of the companies and in another section a breakdown of the fund balance in each of multiple currency units, if applicable;

means for acquiring information on an intra-group settlement when one of the companies in the group clears up an obligation by paying funds to any other company in the group;

means for calculating an applicable rate and converting, at the rate, an amount in a currency unit of a fund pooled on the funds concentration account into an amount in any other currency unit; and

means for updating the balance stored in each section of the received deposits table.

The balance updating means of the above system increases the balance in a predetermined section of the received deposits table according to in-payment information acquired by the in-payment information acquiring means while decreasing the balance in a predetermined section of the received deposits table according to the out-payment information acquired by the out-payment information acquiring means, moves a predetermined amount of money from the balance in a section of the received deposits table for a payer company to the balance in a section of the table for a payee company, and updates the balance according to the change of the balance recorded in the received deposits table from a one before conversion of the currency unit to a one after the currency-unit conversion, in case the currency unit of the fund recorded in the received deposits table has been calculated by the currency unit converting means at any other currency unit.

Also, the above object can be attained by providing an exchange dealing apparatus including according to the present invention:

means for acquiring a currency unit of a fund going to be converted in currency unit;

means for acquiring a currency unit of the fund having been converted in currency unit;

means for acquiring a to-be-converted fund amount in the pre-conversion currency unit;

means for acquiring a date on which the fund is to be converted in currency unit;

means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;

means for acquiring a conversion rate at which the pre-conversion currency unit a company desiring to convert its fund has selected is converted into the post-conversion currency unit; and

means for acquiring an exchange rate in the financial market on the date acquired by the currency change date acquiring means.

In the above exchange dealing apparatus, the currency unit converting means functions to convert the fund amount acquired by the to-be-converted fund amount acquiring means at the conversion rate from an amount in the pre-conversion currency unit into a one in the post-conversion currency unit, when the fund amount converted in currency unit at the conversion rate acquired by the conversion rate acquiring means is larger than that converted in currency unit at the exchange rate acquired by the exchange rate acquiring means; or to add at least a constant proportion of a difference between the exchange rate and conversion rate to the conversion rate and convert the fund amount acquired by the to-be-converted fund amount acquiring means at the resulted rate from an amount in the pre-conversion currency unit into a one in the post-conversion currency unit, when the fund amount converted in currency unit at the conversion rate acquired by the conversion rate acquiring means is smaller than that converted in currency unit at the exchange rate acquired by the exchange rate acquiring means.

Also, the above object can be attained by providing an exchange dealing apparatus including according to the present invention:

means for acquiring a currency unit of a fund going to be converted in currency unit;

means for acquiring a currency unit of the fund having been converted in currency unit;

means for acquiring a to-be-converted fund amount in the pre-conversion currency unit;

means for acquiring a currency change date on which the fund is to be converted in currency unit;

means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;

means for acquiring a conversion rate at which the pre-conversion currency unit a company desiring to convert its fund has selected is converted into the post-conversion currency unit; and

means for acquiring an exchange rate in the financial market on the date acquired by the currency change date acquiring means.

In the above exchange dealing apparatus, the currency unit converting means functions to convert the fund amount acquired by the to-be-converted fund amount acquiring means from an amount in the pre-conversion currency unit into a one in the post-conversion currency unit at the conversion rate, when the fund amount converted in currency unit at the conversion rate acquired by the conversion rate acquiring means is larger than that converted in currency unit at the exchange rate acquired by the exchange rate acquiring means; or to convert the fund amount acquired by the to-be-converted fund amount acquiring means at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the fund amount converted in currency unit at the conversion rate acquired by the conversion rate acquiring means is smaller than that converted in currency unit at the exchange rate acquired by the exchange rate acquiring means.

Also, the above object can be attained by providing an exchange dealing apparatus including according to the present invention:

means for acquiring a currency unit of a fund going to be converted in currency unit;

means for acquiring a currency unit of the fund having been converted in currency unit;

means for acquiring a to-be-converted fund amount in the pre-conversion currency unit;

means for acquiring a currency change date on which the fund is to be converted in currency unit;

means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;

means for acquiring either a first rate at which the pre-conversion currency unit a company desiring to convert its fund has selected is converted into the post-conversion currency unit or a second rate with which the fund amount converted in currency unit is smaller than that converted in currency unit at the first rate; and

means for acquiring an exchange rate in the financial market on the date acquired by the currency change date acquiring means.

In the above exchange dealing apparatus, the currency unit converting means functions to convert the fund amount acquired by the to-be-converted fund amount acquiring means at the first rate from an amount in the pre-conversion currency unit into a one in the post-conversion currency unit, when the first rate is acquired by the rate acquiring means; convert the fund amount acquired by the to-be-converted fund amount acquiring means at the second rate from an amount in the pre-conversion currency unit into a one in the post-conversion currency unit, when the second rate is acquired by the rate acquiring means and the fund amount converted in currency unit at the second rate is larger than that converted in currency unit at the exchange rate acquired by the exchange rate acquiring means; or to add at least a constant proportion of a difference between the exchange rate and second rate to the second rate and convert the fund amount acquired by the to-be-converted fund amount acquiring means at the resulted rate from an amount in the pre-conversion currency unit into a one in the post-conversion currency unit, when the second rate is acquired by the rate acquiring means and the fund amount converted in currency unit at the second rate is smaller than that converted in currency unit at the exchange rate acquired by the exchange rate acquiring means.

Also, the above object can be attained by providing an exchange dealing apparatus including according to the present invention:

means for acquiring a currency unit of a fund going to be converted in currency unit;

means for acquiring a currency unit of the fund having been converted in currency unit;

means for acquiring a to-be-converted fund amount in the pre-conversion currency unit;

means for acquiring a currency changer date on which the fund is to be converted in currency unit;

means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;

means for acquiring either a first rate at which the pre-conversion currency unit a company desiring to convert its fund has selected is converted into the post-conversion currency unit or a second rate with which the fund amount converted in currency unit is smaller than that converted in currency unit at the first rate; and

means for acquiring an exchange rate in the financial market on the date acquired by the currency change date acquiring means.

In the above exchange dealing apparatus, the currency unit converting means functions to convert the fund amount acquired by the to-be-converted fund amount acquiring means at the first rate from an amount in the pre-conversion currency unit into a one in the post-conversion currency unit, when the first rate is acquired by the rate acquiring means; convert the fund amount acquired by the to-be-converted fund amount acquiring means at the second rate from an amount in the pre-conversion currency unit into a one in the post-conversion currency unit, when the second rate is acquired by the exchange rate acquiring means and the fund amount converted in currency unit at the second rate is larger than that converted in currency unit at the exchange rate acquired by the exchange rate acquiring means; or to convert the fund amount acquired by the to-be-converted fund amount acquiring means at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the second rate is acquired by the exchange rate acquiring means and the fund amount converted in currency unit at the second rate is smaller than that converted in currency unit at the exchange rate acquired by the exchange rate acquiring means.

Also, the currency unit converting means in the aforementioned intra-company group funds concentration system may be made up of any of the aforementioned exchange dealing means.

The exchange rate acquired by any one of the aforementioned exchange rate acquiring means may be a spot rate in the interbank dealings or a rate hedged by derivative dealings.

Also, the first rate used in any of the aforementioned exchange dealing apparatuses may be a result of addition or subtraction, to or from a market rate, of a swap being a cost for dealing in futures or a result of subtraction of a predetermined service free from a result of addition or subtraction, to or from a market rate, of a swap being a cost for dealing in futures, and the second rate may be a result of subtraction of a predetermined value from the first rate.

Also, the rate of downing from the first rate to the second rate, used in the aforementioned apparatuses according to the present invention is a function of a ratio of return, to a company desiring to convert its fund, of a profit from a difference between the exchange rate acquired by the exchange rate acquiring means and the second rate. The aforementioned apparatuses according to the present invention may be constructed including a rate down-rate calculating means for making such a calculation based on a predetermined model that an expected value of a difference between a profit and a return to the company will be zero.

The predetermined model may be an optional pricing model.

Also, the above object can be attained by providing an exchange dealing method including according to the present invention:

a first step of acquiring a currency unit of a fund going to be converted in currency unit;

a second step of acquiring a currency unit of the fund having been converted in currency unit;

a third step of acquiring a to-be-converted fund amount in the pre-conversion currency unit;

a fourth step of acquiring a currency change date on which the fund is to be converted in currency unit;

a fifth step of acquiring a conversion rate at which the pre-conversion currency unit a company desiring to convert its fund has selected is converted into the post-conversion currency unit;

a sixth step of acquiring an exchange rate in the financial market on the currency change date unit acquired in the fourth step; and

a seventh step of converting the fund amount acquired in the third step at a predetermined rate from an amount in the currency unit acquired in the first step into a one in the currency unit acquired in the second step.

In the above exchange dealing method, the seventh step is such that when the fund amount converted in currency unit at the conversion rate acquired in the fifth step is larger than that converted in currency unit at the exchange rate acquired in the sixth step, the fund amount acquired in the third step is converted at the conversion rate from an amount in the pre-conversion currency unit into a one in the post-conversion currency unit; or when the fund amount converted in currency unit at the conversion rate acquired in the fifth step is smaller than that converted in currency unit at the exchange rate acquired in the sixth step, at least a constant proportion of a difference between the exchange rate and conversion rate is added to the conversion rate and the fund amount in the third step rate is converted at the resulted rate from an amount in the pre-conversion currency unit into a one in the post-conversion currency unit.

Also, the above object can be attained by providing an exchange dealing method including according to the present invention:

a first step of acquiring a currency unit of a fund going to be converted in currency unit;

a second step of acquiring a currency unit of the fund having been converted in currency unit;

a third step of acquiring a to-be-converted fund amount in the pre-conversion currency unit;

a fourth step of acquiring a currency change date on which the fund is to be converted in currency unit;

a fifth step of acquiring a conversion rate at which the pre-conversion currency unit a company desiring to convert its fund has selected is converted into the post-conversion currency unit;

a sixth step of acquiring an exchange rate in the financial market on the currency change date acquired in the fourth step; and

a seventh step of converting the fund amount acquired in the third step at a predetermined rate from an amount in the currency unit acquired second step into a one in the currency unit acquired in the second step.

In the above exchange dealing method, the seventh step is such that when the fund amount converted in currency unit at the conversion rate acquired in the fifth step is larger than that converted in currency unit at the exchange rate acquired in the sixth step, the fund amount acquired in the third step is converted at the conversion rate from an amount in the pre-conversion currency unit into a one in the post-conversion currency unit; or when the fund amount converted in currency unit at the conversion rate in the fifth step is smaller than that converted in currency unit at the exchange rate acquired in the sixth step, the fund amount acquired in the third step is converted at the conversion rate from an amount in the pre-conversion currency unit into a one in the post-conversion currency unit and then at least a constant proportion of a difference between the fund amounts converted in currency unit at the exchange rate and conversion rate, respectively, is added to the fund amount after converted in currency unit.

Also, the above object can be attained by providing an exchange dealing method including according to the present invention:

a first step of acquiring a currency unit of a fund going to be converted in currency unit;

a second step of acquiring a currency unit of the fund having been converted in currency unit;

a third step of acquiring a to-be-converted fund amount in the pre-conversion currency unit;

a fourth step of acquiring a currency change date on which the fund is to be converted in currency unit;

a fifth step of acquiring either a first rate at which the pre-conversion currency unit a company desiring to convert its fund has selected is converted into the post-conversion currency unit or a second rate with which the fund amount converted in currency unit is smaller than that converted in currency unit at the first rate; and

a sixth step of acquiring an exchange rate in the financial market on the currency change date acquired in the fourth step; and

a seventh step of converting the fund amount acquired in the third step at a predetermined rate from an amount in the currency unit acquired in the first step into a one in the currency unit acquired in the second step.

In the above exchange dealing method, the seventh step is such that when the first rate is acquired in the fifth step, the fund amount acquired in the third step is converted at the first rate from an amount in the pre-conversion currency unit into a one in the post-conversion currency unit; when the second rate is acquired in the fifth step and the fund amount converted in currency unit at the second rate is larger than that converted in currency unit at the exchange rate acquired in the sixth step, the fund amount acquired in the third step is converted at the second rate from an amount in the pre-conversion currency unit into a one in the post-conversion currency unit; or when the second rate is selected in the fifth step and the fund amount converted in currency unit at the second rate is smaller than that converted in currency unit at the exchange rate acquired in the sixth step, at least a constant proportion of a difference between the exchange rate and second rate is added to the second rate and the fund amount acquired in the third step is converted at the resulted rate from an amount in the pre-conversion currency unit into a one in the post-conversion currency unit.

Also, the above object can be attained by providing an exchange dealing method including according to the present invention:

a first step of acquiring a currency unit of a fund going to be converted in currency unit;

a second step of acquiring a currency unit of the fund having been converted in currency unit;

a third step of acquiring a to-be-converted fund amount in the pre-conversion currency unit;

a fourth step of acquiring a currency change date on which the fund is to be converted in currency unit;

a fifth step of acquiring either a first rate at which the pre-conversion currency unit a company desiring to convert its fund has selected is converted into the post-conversion currency unit or a second rate with which the fund amount converted in currency unit is smaller than that converted in currency unit at the first rate;

a sixth step of acquiring an exchange rate in the financial market on the currency change date acquired in the fourth step; and

a seventh step of converting the fund amount acquired in the third step at a predetermined rate from an amount in the currency unit acquired in the first step into a one in the currency unit acquired in the second step.

In the above exchange dealing method, the seventh step is such that when the first rate is acquired in the fifth step, the fund amount acquired in the third step is converted at the first rate from an amount in the pre-conversion currency unit into a one in the post-conversion currency unit; when the second rate is acquired in the fifth step and the fund amount converted in currency unit at the second rate is larger than that converted in currency unit at the exchange rate acquired in the sixth step, the fund amount acquired in the third step is converted at the second rate from an amount in the pre-conversion currency unit into a one in the post-conversion currency unit; or when the second rate is acquired in the fifth step and the fund amount converted in currency unit at the second rate is smaller than that converted in currency unit at the exchange rate acquired in the sixth step, the fund amount acquired in the third step is converted at the second rate from an amount in the pre-conversion currency unit into a one in the post-conversion currency unit and then at least a constant proportion of a difference between the fund amounts converted in currency unit at the exchange rate and second rate, respectively, is added to the fund amount after converted in currency unit.

Also, the above object can be attained by providing a computer-readable recording medium having stored therein an exchange dealing program causing a computer according to the present invention to perform functions to:

acquire a currency unit of a fund going to be converted in currency unit;

acquire a currency unit of the fund having been converted in currency unit;

acquire a to-be-converted fund amount in the pre-conversion currency unit;

acquire a currency change date on which the fund is to be converted in currency unit;

convert the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;

acquire a conversion rate at which the pre-conversion currency unit a company desiring to convert its fund has selected is converted into the post-conversion currency unit; and

acquire an exchange rate in the financial market on the date acquired by the currency change date acquiring function.

In the exchange dealing program in the above recording medium, the currency unit converting function is to convert the fund amount acquired by the to-be-converted fund amount acquiring function at the conversion rate from an amount in the pre-conversion currency unit into a one in the post-conversion currency unit, when the fund amount converted in currency unit at the conversion rate acquired by the conversion rate acquiring function is larger than that converted in currency unit at the exchange rate acquired by the exchange rate acquiring function; or to add at least a constant proportion of a difference between the exchange rate and conversion rate to the conversion rate and convert the fund amount acquired by the to-be-converted fund amount acquiring function at the resulted rate from an amount in the pre-conversion currency unit into a one in the post-conversion currency unit, when the fund amount converted in currency unit at the conversion rate acquired by the conversion rate acquiring function is smaller than that converted in currency unit at the exchange rate acquired by the exchange rate acquiring function.

Also, the above object can be attained by providing a computer-readable recording medium having stored therein an exchange dealing program causing a computer according to the present invention to perform functions to:

acquire a currency unit of a fund going to be converted in currency unit;

acquire a currency unit of the fund having been converted in currency unit;

acquire a to-be-converted fund amount in the pre-conversion currency unit;

acquire a currency change date on which the fund is to be converted in currency unit;

convert the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;

acquire a conversion rate at which the pre-conversion currency unit a company desiring to convert its fund has selected is convened into the post-conversion currency unit; and

acquire an exchange rate in the financial market on the date acquired by the currency change date acquiring function.

In the exchange dealing program in the above recording medium, the currency unit converting function is to convert the fund amount acquired by the to-be-converted fund amount acquiring function from an amount in the pre-conversion currency unit into a one in the post-conversion currency unit at the conversion rate, when the fund amount converted in currency unit at the conversion rate acquired by the conversion rate acquiring function is larger than that converted in currency unit at the exchange rate acquired by the exchange rate acquiring function; or to convert the fund amount acquired by the to-be-converted fund amount acquiring function at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the fund amount converted in currency unit at the conversion rate acquired by the conversion rate acquiring function is smaller than that converted in currency unit at the exchange rate acquired by the exchange rate acquiring function.

Also, the above object can be attained by providing a computer-readable recording medium having stored therein an exchange dealing program causing a computer according to the present invention to perform functions to:

acquire a currency unit of a fund going to be converted in currency unit;

acquire a currency unit of the fund having been converted in currency unit;

acquire a to-be-converted fund amount in the pre-conversion currency unit;

acquire a currency change date on which the fund is to be converted in currency unit;

convert the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;

acquire either a first rate at which the pre-conversion currency unit a company desiring to convert its fund has selected is converted into the post-conversion currency unit or a second rate with which the fund amount converted in currency unit is smaller than that converted in currency unit at the first rate; and

acquire an exchange rate in the financial market on the date acquired by the currency change date acquiring function.

In the exchange dealing program in the above recording medium, the currency unit converting function is to convert the fund amount acquired by the to-be-converted fund amount acquiring function at the first rate from an amount in the pre-conversion currency unit into a one in the post-conversion currency unit, when the first rate is acquired by the rate acquiring function; convert the fund amount acquired by the to-be-converted fund amount acquiring function at the second rate from an amount in the pre-conversion currency unit into a one in the post-conversion currency unit, when the second rate is acquired by the rate acquiring function and the fund amount converted in currency unit at the second rate is larger than that converted in currency unit at the exchange rate acquired by the exchange rate acquiring function; or to add at least a constant proportion of a difference between the exchange rate and second rate to the second rate and convert the fund amount acquired by the to-be-converted fund amount acquiring function at the resulted rate from an amount in the pre-conversion currency unit into a one in the post-conversion currency unit, when the second rate is acquired by the rate acquiring function and the fund amount converted in currency unit at the second rate is smaller than that converted in currency unit at the exchange rate acquired by the exchange rate acquiring function.

Also, the above object can be attained by providing a computer-readable recording medium having stored therein an exchange dealing program causing a computer according to the present invention to perform functions to:

acquire a currency unit of a fund going to be converted in currency unit;

acquire a currency unit of the fund having been converted in currency unit;

acquire a to-be-converted fund amount in the pre-conversion currency unit;

acquire a date on which the fund is to be converted in currency unit;

a function for converting the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;

acquire either a first rate at which the pre-conversion currency unit a company desiring to convert its fund has selected is converted into the post-conversion currency unit or a second rate with which the fund amount converted in currency unit is smaller than that converted in currency unit at the first rate; and

acquire an exchange rate in the financial market on the date acquired by the currency change date acquiring function.

In the exchange dealing program in the above recording medium, the currency unit converting function is to convert the fund amount acquired by the to-be-converted fund amount acquiring function at the first rate from an amount in the pre-conversion currency unit into a one in the post-conversion currency unit, when the first rate is acquired by the rate acquiring function; convert the fund amount acquired by the to-be-converted fund amount acquiring function at the second rate from an amount in the pre-conversion currency unit into a one in the post-conversion currency unit, when the second rate is acquired by the rate acquiring function and the fund amount converted in currency unit at the second rate is larger than that converted in currency unit at the exchange rate acquired by the exchange rate acquiring function; or to convert the fund amount acquired by the to-be-converted fund amount acquiring function at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the second rate is acquired by the rate acquiring function and the fund amount converted in currency unit at the second rate is smaller than that converted in currency unit at the exchange rate acquired by the exchange rate acquiring function.

Also, the above object can be attained by providing a currency change server computer for providing a currency change service to a company upon request from the latter, the computer including according to the present invention:

means for receiving, from the company, a request for currency change of a money from a first currency unit to a second currency unit, which also specifies an amount of money to be converted in currency unit;

means for calculating an exchange rate set when the currency change request is received by the request receiving means and an amount of profit based on the conversion amount of money and coining from a difference between the first and second currency units with which the money has actually been converted in currency unit; and

means for returning, to the company, an amount of money calculated based on the profit amount and conversion money amount.

The above currency change server computer further includes means for converting a money at any one of the exchange rate set when the currency change request is received by the request receiving means and an exchange rate which is when the currency change is made, whichever will provide a larger amount of money converted in currency unit.

The currency change server computer further includes a partial exchanging means for converting a money from an amount in a first currency unit into a one in a second currency unit via currency change between the one in the first currency unit and a one in a third currency unit.

Also, the above object can be attained by providing a currency change method of providing a currency change service to a company upon request from the latter, the method including according to the present invention:

a first step of receiving, from the company, a request for currency change of a money from a first currency unit to a second currency unit, which also specifies an amount of money to be converted in currency unit;

a second step of calculating an exchange rate set when the currency change request is received in the first step and an amount of profit based on the conversion amount of money and coming from a difference between the first and second currency units with which the money has actually been converted in currency unit; and

a third step of returning, to the company, an amount of money based on the profit amount calculated in the second step.

Also, the above object can be attained by providing a currency change server program for providing a currency change service to a company upon request from the latter, the program causing a currency change server computer according to the present invention to perform functions to:

receive, from the company, a request for currency change of a money from a first currency unit to a second currency unit, which also specifies an amount of money to be converted in currency unit;

calculate an exchange rate set when the currency change request is received by the request receiving function and an amount of profit based on the conversion amount of money and coming from a difference between the first and second currency units with which the money has actually been converted in currency unit; and

return, to the company, an amount of money calculated based on the profit amount and conversion money amount.

Also, the above object can be attained by providing a currency change client computer for making a request to a managing company of a group of companies for providing a currency change service, the computer including according to the present invention:

means for making, to the currency change server computer at the managing company, a request for currency change of a money from a first currency unit to a second currency unit, which also specifies an amount of the money to be converted in currency unit; and

means for receiving, from the currency change server computer, an amount of money based on the profit amount calculated based on a difference between an exchange rate set when the currency change request has been made by the request making means and a one at which the money has been converted.

Also, the above object can be attained by providing a method for making a request to a managing company of a group of companies for providing a currency change service, the method including according to the present invention:

a first step of making, to the currency change server computer at the managing company, a request for currency change of a money from a first currency unit to a second currency unit, which also specifies an amount of the money to be converted in currency unit; and

a second step of receiving, from the currency change server computer, an amount of money based on the profit amount calculated based on a difference between an exchange rate set when the currency change request has been made in the first step and a one at which the money has been converted.

Also, the above object can be attained by providing a currency change request client program for making a request to a managing company of a group of companies for providing a currency change service, the program causing a currency change request client computer according to the present invention to perform functions to:

make, to the currency change server computer at the managing company, a request for currency change of a money from a first currency unit to a second currency unit, which also specifies an amount of the money to be converted in currency unit; and

receive, from the currency change server computer, an amount of money based on the profit amount calculated based on a difference between an exchange rate set when the currency change request has been made by the request making function and a one at which the money has been converted.

Also, the above object can be attained by providing a currency change server computer for providing a currency change service to a company upon request from the latter, the computer including according to the present invention:

means for identifying a currency unit pair to hedge against exchange risk;

a currency change request acquiring means for acquiring, from the company, a first conversion-source currency unit, second conversion-destination currency unit and an amount of money to be converted in currency unit;

means for determining whether the pair of first and second currency units acquired by the currency change request acquiring means is included in the currency pair identified by the identifying means; and

means for converting the money from an amount in the first currency unit to a one in the second currency unit when it is determined by the determining means that the pair of the first and second currency units is included in the currency unit pair identified by the identifying means; or from an amount in the first currency unit into a one in the second currency unit via currency change between the currency units included in the currency unit pair identified by the identifying means when it is determined by the determining means that the pair of the first and second currency units is not included in the currency unit pair identified by the identifying means.

The above currency change server computer further includes a profit returning means for returning, to the company, a part of a profit from a difference between an exchange rate set when the company has made the currency change request and an exchange rate used for the currency change between the currency rates in pair.

In the currency change server computer, the identifying means includes:

means for sorting the currency unit into a base currency unit or a subordinate currency unit;

means for relating each of subordinate currency units sorted by the sorting means with any one of base currency units; and

means for generating a currency pair from two of the base currency units sorted by the sorting means or from the base currency unit and subordinate currency units, related with each other by the relating means.

Also, the above object can be attained by providing a currency change method for providing a currency change service to a company upon request from the latter, the method including according to the present invention:

a first step of identifying a currency unit pair to hedge against exchange risk;

a second step of acquiring, from the company, a first conversion-source currency unit, second conversion-destination currency unit and an amount of money to be converted in currency unit;

a third step of determining whether the pair of first and second currency units acquired in the second step is included in the currency pair identified in the first step; and

a fourth step of converting the money from an amount in the first currency unit into a one in the second currency unit according to a determined made in the third step.

In the above fourth step, the money is converted from an amount in the first currency unit into a one in the second currency unit when it is determined in the third step that the pair of the first and second currency units is included in the currency unit pair identified in the first step, or from an amount in the from an amount in the first currency unit to a one in the second currency unit via currency change between the currency units included in the currency unit pair identified in the first step when it is determined in the third step that the pair of the first and second currency units is not included in the currency unit pair identified in the first step.

The above first step includes:

a 1a-th step of sorting the currency unit into a base currency unit or subordinate currency unit;

a 1b-th step of relating each subordinate currency unit sorted in the 1a-th step with any one of base currency units; and

a 1c-th step of generating a currency pair from two base currency units sorted in the 1a-th step or from the base currency unit and subordinate currency unit, related with each other in the 1b-th step.

Also, the above object can be attained by providing a currency change server program for providing a currency change service to a company upon request from the latter, the program causing a currency change server computer according to the present invention to perform functions to:

identify a currency unit pair to hedge against exchange risk;

acquire, from the company, a first conversion-source currency unit, second conversion-destination currency unit and an amount of money to be converted in currency unit;

determine whether the pair of first and second currency units acquired by the currency change request acquiring function is included in the currency pair identified by the identifying function; and

convert the money from an amount in the first currency unit to a one in the second currency unit when it is determined by the determining function that the pair of the first and second currency units is included in the currency unit pair identified by the identifying function; or from an amount in the first currency unit to a one in the second currency unit via currency change between the currency units included in the currency unit pair identified by the identifying function when it is determined by the determining function that the pair of the first and second currency units is not included in the currency unit pair identified by the identifying function.

The above identifying function includes functions to:

sort the currency unit into a base currency unit or subordinate currency unit;

relate each subordinate currency unit sorted by the sorting function with any one of base currency units; and

generate a currency pair from two base currency units sorted by the sorting function or from the base currency unit and subordinate currency unit, related with each other by the relating function.

Also, the above object can be attained by providing a netting apparatus including according to the present invention:

means for recording the balance on the account of each customer company in each currency unit;

an in-payment information acquiring means for acquiring an in-payment date, in-payment currency unit and in-payment amount of a fund transferred into the account of the customer company; and

an out-payment information acquiring means for acquiring an out-payment date, out-payment currency unit, and out-payment amount of a fund paid from the account of the customer company into the account of any other company, and a payee company;

the recording means making a netting by moving at least a part of the amount of in-payment into the account of the customer company to the balance on the account of the other customer company when the payee company acquired by the in-payment information acquiring means is an other customer company, the in-payment date acquired by the in-payment information acquiring means is the same as the out-payment date acquired by the out-payment information acquiring means and the in-payment currency unit acquired by the in-payment information acquiring means is the same as the out-payment currency unit acquired by the out-payment information acquiring means.

Also, the above object can be attained by providing a netting method including according to the present invention:

a first step of recording the balance on the account of each customer company in each currency unit;

a second step of acquiring an in-payment date, in-payment currency unit and in-payment amount of a fund transferred into the account of the customer company;

a third step of acquiring an out-payment date, out-payment currency unit, and out-payment amount of a fund paid from the account of the customer company into the account of any other company, and a payee company; and

a fourth step of making a netting by moving at least a part of the amount of in-payment into the account of the customer company to the balance on the account of the other customer company when the payee company acquired in the third step is an other customer company, the in-payment date acquired in the second step is the same as the out-payment date acquired in the third step and the in-payment currency unit acquired in the second step is the same as the out-payment currency unit acquired in the third step.

Also, the above object can be attained by providing a netting program causing a computer according to the present invention to perform functions to:

record the balance on the account of each customer company in each currency unit;

acquire an in-payment date, in-payment currency unit and in-payment amount of a fund transferred into the account of the customer company; and

acquire an out-payment date, out-payment currency unit, and out-payment amount of a fund paid from the account of the customer company into the account of any other company, and a payee company;

make a netting by moving at least a part of the amount of in-payment into the account of the customer company to the balance on the account of the other customer company when the payee company acquired by the in-payment information acquiring means is an other customer company, the in-payment date acquired by the in-payment information acquiring means is the same as the out-payment date acquired by the out-payment information acquiring means and the in-payment currency unit acquired by the in-payment information acquiring means is the same as the out-payment currency unit acquired by the out-payment information acquiring means. This netting program is stored in a computer-readable recording medium.

These objects and other objects, features and advantages of the present invention will become more apparent from the following detailed description of the best mode for carrying out the present invention when taken in conjunction with the accompanying drawings.

### BRIEF DESCRIPTION OF THE DRAWINGS

FIG. 1 is a block diagram of the centralized funds management system according to the present invention.

FIG. 2 is a block diagram of the funds management system according to the present invention.

FIG. 3 is a block diagram of the currency change unit.

FIG. 4A shows the method of determining a quarter-type company rate, and a rate-applied term; and FIG. 4B shows the method of determining a monthly-type company rate, and a rate-applied term.

FIG. 5 explains the premium rate.

FIG. 6 explains the premium setting standard.

FIG. 7 shows an example of exchange profit return in case the market rate type is adopted.

FIG. 8 shows an example of exchange profit return in case the hedge rate type is adopted.

FIG. 9 shows that the market rate is lower than the premium rate on the date of settlement in case the market rate type is adopted.

FIG. 10 shows a flow of operations made by the currency change unit in case the funds concentration system is given directions for converting a fund in yens into a one in dollars for payment to the payee company.

FIG. 11 is a block diagram showing an example of the banking system.

FIG. 12 explains the basic concept of the currency change method conducted according to the present invention.

FIG. 13A shows a received deposits table; FIG. 13B shows the funds concentration account.

FIG. 14 is a block diagram showing another example of the currency change unit.

FIG. 15 shows a concrete example of a currency change between subordinate currencies.

FIG. 16 shows a flow chart for explaining a logic for determining whether partial change (indirect conversion) is to be done.

### BEST MODE FOR CARRYING OUT THE INVENTION

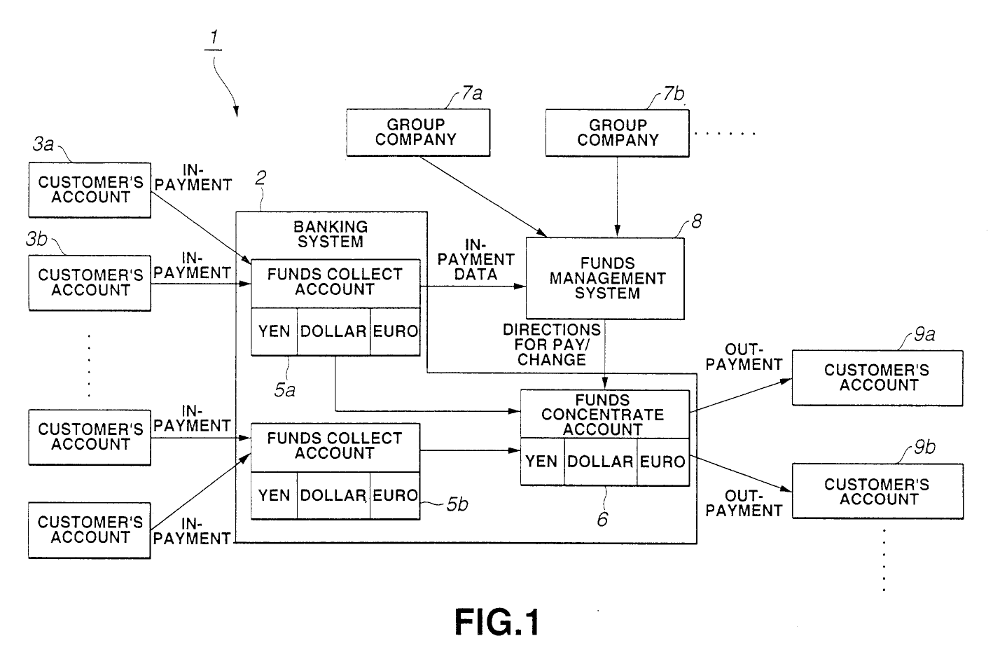

The preferred embodiments of the present invention will be described herebelow with reference to FIGS. 1 to 10.

Referring now to FIG. 1, there is schematically illustrated in the form of a block diagram the centralized funds management system according to the present invention. The system is generally indicated with a reference 1.

The centralized funds management system 1 concentrates a fund of each of companies 7a, 7b, . . . , belonging to a group (will be referred to as “group company” hereunder wherever no differentiation is made between the companies) to one account for collective management. The “group companies” refer to companies which have some business with each other or only from one to another whether they have any financed relation with each other, and are conceptually broader than any subsidiary, affiliated company and associated undertaking. Note that although there are shown only two group companies 7a and 7b in FIG. 1, the number of group companies is not limited to two but more group companies can participate into the company group or the system 1.

The centralized funds management system 1 includes a banking system 2. The banking system 2 is a computerized system including a server unit or the like and provided in a bank. The banking system 2 includes a storage unit, ROM (read-only memory), RAM (random-access memory), input/output unit, central controller, communication controller, etc.

The storage unit includes a fixed disc storage unit or the like, having recorded therein a data base having recorded therein a balance on the customer's account, log file having recorded therein transactions such as in-payment to and out-payment from each account, updating program which updates the balance in account recorded in the data base, communication program to communicate with any other bank, process in-payment data sent from the other bank and send remittance data to the other bank, necessary programs for the banking services, etc.

The ROM has stored therein OS (operating system) and various basic programs.

The RAM buffers a program stored in the storage unit and going to be executed, and provides a working memory for the operation of the CPU (central processing unit).

The central controller incorporates a CPU to control the banking system 2 as a whole by controlling input and output of data to and from the input/output unit according to various programs stored in the storage unit, updating, by rewriting, the balance in account recorded in the data base, preparing a log file, or maintaining the communications with any system other than the banking system 2.

The communication controller connects with a banking system and the like other than the banking system 2 via a communication network to communicate, along with the central controller, with an external system for reception of in-payment data and sending remittance data.

In the banking system 2, there are provided funds collection accounts 5a, 5b, . . . and a funds concentration account 6. They are provided as a data base having the balance in account and the like recorded in a storage unit in the banking system 2.

Note that as will be described in detail later, each of the funds collection accounts 5a, 5b, . . . ad funds concentration account 6 consists of accounts for currency units such as yen, dollar, Euro and others for concentration of funds in each of the currency units.

The funds collection accounts 5a, 5b, . . . are provided for each of the group companies 7a, 7b, . . . Only the funds collection account 5a for the group company 7a will be described for the simplicity of illustration and explanation since the other funds collection accounts 5b, . . . have also the same construction and functions as those of the account 5b.

In-payments to the group company from outside the group, such as proceeds acquired by the group company 7a by selling pieces of merchandise, are collectively transferred from customer's accounts 3a, 3b, . . . into the funds collection account 5a which is only one account for the company group.

Specifically, the banking system 2 receives in-payment data from the systems of banks in which the customers have their accounts 3a, 3b, . . . , and the central controller updates the data on the balance in the funds collection account 5a. Also, the group companies have already asked each of the customers for transferring a settlement amount into the funds collection account 5a.

The currency units of the funds paid into the account 5a are yen, dollar, Euro, etc. For example, when the company 7a sold a car in France and received the payment for the car in Euros, or when the company 7a sold an industrial robot to a customer in the USA and receives the payment in US dollars, the money in Euros and dollars will be paid into the funds collection account 5a. It should be noted that the US dollars will be referred to simply as “dollars” hereunder.

For example, when the customer pays a settlement amount in dollars into the funds collection account 5a, the money will be paid into the account for dollars, of the accounts for various currency units included in the funds collection account 5a. Namely, the customer will pay a settlement amount into an account corresponding to the currency unit in which it makes the settlement.

When the balance in the funds collection account 5a is updated with the in-payment data, the central controller of the banking system 1 will send the in-payment data to a funds management system 8 installed at the managing company of the group over the private line via the communication controller. The managing company of the company group is a one selected from among the group companies 7a, 7b, . . . , a company established by the group companies 7a, 7b, . . . for the purpose of centralized management of their funds, or a third party charged in the centralized funds management. The managing company manages the recording of in-payments to the group companies 7a, 7b, . . . and acts for the group companies 7a, 7b, . . . to make payment.

The in-payment data include information such as the name of a company having made the payment, in-payment amount, currency unit, for what the in-payment is, etc.

The fund paid into the funds collection account 5a is moved by the banking system 2 to the funds concentration account 6 on the same day.

More particularly, for example, a fund paid into the dollar account in the funds collection account 5a will be moved to an account, for a fund in dollars, of accounts for various currency units in the funds concentration account 6. Namely, the fund movement from the funds collection account 5a to the funds concentration account 6 is made between accounts for corresponding currency units.

The record of balance in the funds concentration account 6 is sectioned for multiple currency units, and the banking system 2 updates the balance record in each section of the account 6 according to the currency unit of a paid-in fund. For example, when data as to an in-payment of 20,000,000 dollars to the funds collection account 5a is received, the balance record in the dollar account of the funds concentration account 6 is raised by 20,000,000 dollars, and when a money of 10 billion yens has been paid in, the balance record in the yen account is raised by 10 billion yens.

Note that although yens, dollars and Euros are used as the currency units in this embodiment, the currency units are not limited them but other currency units may be used. Also, funds in yens, dollars and Euros are dealt with in one bank in this embodiment, but a fund in a currency unit may be pooled in one bank. For example, a fund in yens may be pooled in a Japanese bank, a fund in dollars be in a US bank and a fund in Euros be in a German bank, and these banks may be connected to the funds management system 8 at the managing company over a telephone line to manage the funds in the respective banks. Also, in this embodiment, a bank in which the funds concentration account 6 is set is charged in the foreign exchange for the group of companies, to which however the present invention is not limited, but a banking establishment to be charged in the foreign exchange for the company group may be other than the bank in which the funds concentration account 6 is provided.

The funds management system 8 installed in the managing company includes a funds management server having stored therein a funds management program and various data bases, for example.

The funds management system 8 is connected by a private line to the banking system 2 to receive in-payment data from the banking system 2 and send, to the banking system 2, payment directions for remittance of money from the funds concentration account 6 to a predetermined account.

Also, the funds management system 8 is connected by the private lines to terminal units at the companies 7a, 7b, . . . The terminal unit provided at each of the group companies includes a CPU, storage unit, RAM, ROM, communication controller, keyboard, display unit, etc. The storage unit has stored therein a communication program intended for communications with the funds management system 8, other necessary programs, data bases, etc.

The display unit of the terminal unit at each group company displays a menu screen from the funds management system 8, and at each company, a person in charge can select, on the menu screen, each of items such as “balance inquiry”, “pay to ex-group company”, “pay to group company”, “request for currency change”, etc.

Operating the terminal unit to select a necessary item from the menu screen, the person in charge can give directions for display of the balance in account, currency change or payment, etc. to the funds management system 8.

When the person in charge wants to see the balance in account, for example, he or she selects the item “balance inquiry” from the menu screen. Then, a request for balance inquiry is sent from the terminal unit to the funds management system 8 via the communication network. Receiving the balance inquiry request, the funds management system 8 will display a balance inquiry screen on the display unit of the terminal unit. The person in charge enters required matters such as a currency unit with which the balance inquiry is to be made to prepare balance inquiry data on the balance inquiry screen, and then sends the data to the funds management system 8. Receiving the balance inquiry request from the terminal unit at the group company, the funds management system 8 reads the received deposits table having recorded therein a fund balance of each group company and displays the fund balance of the group company on the display unit of the terminal unit at the group company having made the balance inquiry request.

Note that the connection between the terminal unit at each group company and the funds management system 8, or the connection between the banking system 2 and funds management system 8, may be made via the Internet, communication network using an artificial satellite, communication network using a cable TV network, mobile communication network, etc., not only by the private line. Also, the centralized funds management system 1 assures the security by encoding the communication data, setting a password for connection to the terminal unit, etc.

The funds management system 8 has stored therein a data base having recorded therein a received deposits table which will further be described later to know the balances of various group companies. The “received deposits table” refers to a table having recorded therein a breakdown of each group company having its fund pooled in the funds concentration account 6 prepared in the data base. The received deposits table is further sectioned for currency units. For example, when the group company 7a has funds in yens, dollars and Euros pooled in the funds concentration account 6, the balances of the company 7a are recorded in the received deposits table correspondingly to the yen, dollar and Euro, respectively.

When the group company makes a settlement by remitting money to an ex-group customer, it sends a payment request from its own terminal unit to the funds management system 8. Then, the funds management system 8 will send directions for payment to the banking system 2. Receiving the payment directions from the funds management system 8, the banking system 2 will make a corresponding remittance from the funds concentration account 6 to a designated one of the customer's accounts 9a, 9b,. . . . The funds management system 8 will update the corresponding balance in the received deposits table.

The funds management system 8 has also a function supporting an change of a fund pooled in the funds concentration account 6 from an amount in a currency unit into a one in another currency unit.

Note that the “currency change” in the description given herein means an instant conversion of one currency to another as well as dealings in futures, step transaction, option transaction, etc. It broadly means an action to change one currency to another at any time. However, where both “exchange” and “currency change” are used together, their respective general definitions will be followed.

For example, when the group company 7a changes its own fund in dollars into an amount in yens or makes a payment in dollars from its own fund in yens to a customer's account 9b, the funds management system 8 can calculate a conversion amount at a predetermined rate and update the balance in the received deposits table correctly.

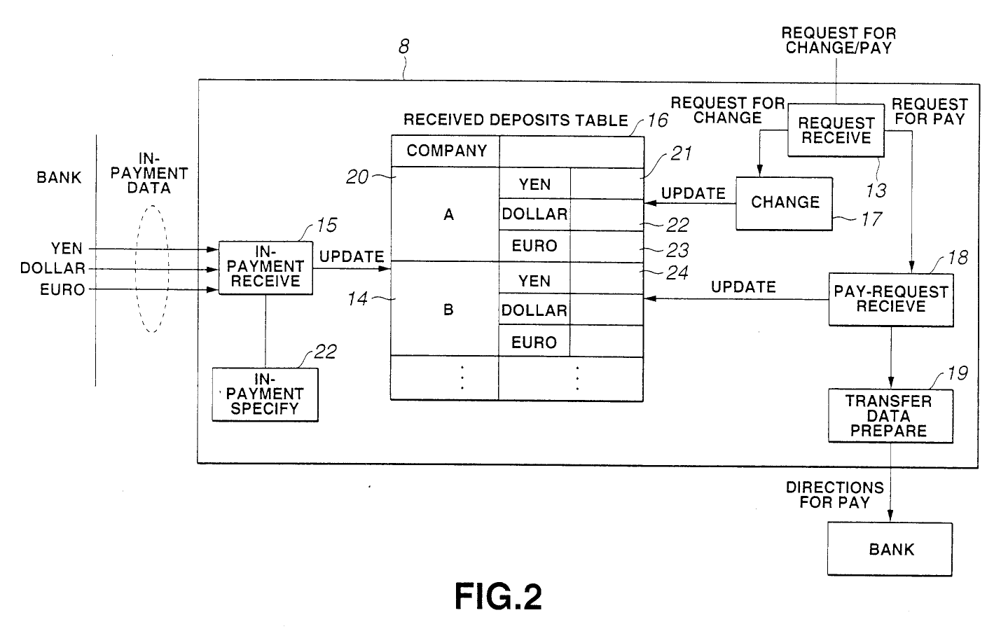

Referring now to FIG. 2, there is illustrated in more detail in the form of a block diagram the funds management system 8 according to the present invention.

As shown, the funds management system 8 includes an in-payment reception unit 15, in-payment specification unit 22, currency change unit 17, payment request reception unit 18, transfer data preparation unit 19, request reception unit 13, central controller, fixed disc, etc. (not shown). Further, the system 8 includes a storage unit having stored therein various data bases, programs, etc., ROM having basic programs stored therein, RAM which loads a program in the storage unit and provides a working memory for the CPU in the central controller, communication controller to make communications with the banking system 2 and terminal units of the group companies via the communication network, etc.

The funds management system 8 has provided in the data base a received deposits table 16 to which reference is made to know the breakdown of a fund own by each company. The received deposits table 16 is a virtual account provided for each group company, The virtual account is sectioned for each of the currency units such as yen, dollar and Euro and the account sections have recorded therein funds of each company in yens, dollars and Euros, respectively.

The in-payment reception unit 15 is online connected to the banking system 2 via the communication controller (not shown). When receiving in-payment data from the banking system 2, the in-payment reception unit 15 is controlled by the central controller to update, by rewriting, a relevant balance record in the received deposits table 16 and transfer the in-payment data to the in-payment specification unit 22.

Receiving the in-payment data from the in-payment reception unit 15, the in-payment specification unit 22 generates an in-payment specification log in a predetermined form, and stores it into the storage unit. Each of the group companies can download the in-payment specification log about itself to its terminal unit via the communication network and display the log on the display unit. Also, each company can check accounts receivable with reference to the in-payment specification log and collate the accounts receivable specification with the in-payment specification.

The in-payment data includes a name of payer company, remitter, currency unit, amount of money, date of transfer, in-payment item, etc.

For example, when 2,000,000 dollars has been paid into the funds collection account 5a for the company A, the in-payment reception unit 15 adds the 2,000,000 dollars to the balance record in a dollar area 22 of a virtual account 20 of the company A, and updates, by rewriting, the balance record.

In case a group company wants to pay money to its customer's account not belonging to its group by remittance, the personal in charge of the company selects the item “pay to ex-group company” on the menu screen from the funds management system 8, displayed on the terminal unit at the company, and sends a request for payment to ex-group company to the funds management system 8. Receiving the request, the central controller of the funds management system 8 will display an ex-group payment input screen on the terminal unit of the group company according to a payment request program stored in the storage unit. The person in charge of that company enters required mattes to the ex-group payment input screen to prepare ex-group payment request data.

The ex-group payment request data includes the name of the ex-group company, number of the customer's account, money amount, item of payment, currency unit of a fund to be paid, currency unit for the remittance, etc.

Receiving the ex-group payment request data via the request reception unit 13, the payment request reception unit 18 will update the balance record of that company in the received deposits table 16, and send the ex-group payment request data to the transfer data preparation unit 19. For example, when the company A pays a money of one billion yens from a fund in yens, one billion yens is reduced form the balance record in a yen area 21 of the virtual account 20 of the company A. Thus, the balance record is updated. The request reception unit 13 distributes data sent from the terminal unit of each group company to the currency change unit 17 and payment request reception unit 18. Also, data for transfer between the currency change unit 17 and payment request reception unit 18 is passed through the request reception unit 13.

Also, when the currency unit at the payer is different from that at the payee, the central controller of the funds management system 8 will prepare change data from the ex-group payment data, and send it to the currency change unit 17.

The payment request reception unit 18 will be activated after the currency change unit 17 updates the received deposits tale 16 at a predetermined exchange rate according to the change data.

For example, it is assumed here that the company A remits a money of 100,000 dollars from its fund in yens, recorded in the yen area 21 to the customer's account and one dollar is convertible with 100 yens. The currency change unit 17 will subtract 10,000,000 yens from the balance record in the yen area 21 while adds 100,000 dollars to the balance record in the dollar area 22, and thus update the received deposits table 16.

Thereafter, the payment request reception unit 18 will subtract 100,000 dollars from the balance record in the dollar area 22 of the received deposits table 16 and directs the transfer data preparation unit 19 to prepare transfer data for remittance of the 100,000 dollars to a predetermined account.

Receiving the ex-group payment request data from the payment request reception unit 18, the transfer data preparation unit 19 will prepare transfer data in a predetermined format for directing the banking system 2 to remit the money from the funds concentration account 6 to the customer's accounts 9a, 9b, . . . , and send the transfer data to the banking system 2.

The currency change unit 17 will be described in more detail later.

In case a group company remits a money to any other group company, the fund pooled in the funds concentration account 6 is not moved but only the balance data in the received deposits table 16 is updated.

When a group company wants to remit a money to any other group company, the person in charge selects the item “pay to intra-group company” from the menu screen on its terminal unit, and sends intra-group payment request to the funds management system 8.

Receiving the intra-group payment request, the central controller of the funds management system 8 displays an intra-group payment input screen on the display unit of the terminal unit of that group company according to the payment request program stored in the storage unit. The person in charge of that group company will enter necessary matters to the payment input screen to prepare intra-group payment request data, and send the data to the funds management system 8.

The intra-group payment request data includes the name of payer group company, name of payee group company, currency unit of fund of the payer, currency unit of payment, money amount, remittance item indicating for what the payment is to be done, etc.

Receiving the payment request data, the central controller of the payment request reception unit 18 rewrites only the fund balance data in the received deposits table 16 without sending the data to the transfer data preparation unit 19, whereby a settlement is done within the group.

For example, when the company A wants to remit a money of 20,000,000 yens to a company B, the payment request reception unit 18 subtracts 20,000,000 yens from the balance data in the yen area 21 of the virtual account 20 of the company A while adding 20,000,000 yens to the balance data in a yen area 24 of the company B. The payment request reception unit 18 will not send the intra-group payment request data to the transfer data preparation unit 19 and no funds concentrated to the funds concentration account 6 will be moved.

Also, when the currency unit of the fund of the payer is different from that of the payment, the central controller of the funds management system 8 will prepare change data from the intra-group payment request data and send it to the currency change unit 17. The currency change unit 17 makes a change calculation and updates the balance record in the received deposits table 16, and then makes a settlement.

For example, when the company A wants to pay a money of one billion yens from the balance recorded in a Euro area 23 of the virtual account 20 to the company B and the exchange rate is calculated by the currency change unit 17 to be 100 yens/Euro, the currency change unit 17 will subtract 1,000,000 Euros from the balance record in the Euro area 23 while adding one billion yens to the balance record in the yen area 21. Thereafter, the payment request reception unit 18 will subtract one billion yens from the balance record in the yen area 24 of the company A while adding one billion yens to the balance record in the yen area 21 of the company B. For this while, no funds concentrated in the funds concentration account 6 will be moved.

As above, the funds management system 8 can reduce the change for money transfer and number of operations for the transfer in case of an intra-group settlement.

Also, since it is not necessary to prepare any money for settlement on a due date of settlement for any of the group companies, an exposure of foreign exchange (a fund is exposed to an exchange risk; for example, it will take place with a fund prepared for settlement or a foreign-currency fund to be received in future) can be avoided.

Note that although the surrogate payment request from each group company is different from intra-group company to ex-group company as having been described above, only “payment request” may be displayed on the display unit of the terminal unit of each group company, the central controller of the funds management system 8 may judge, based on a company name included in the payment request data, which the company is, an ex-group company or an intra-group company, namely, a group company, and a procedure may be taken based on the result of judgment.

The funds management system 8 has an interest calculation program stored in the storage unit, and an interest calculated by the central controller according to the interest calculation program is added to the balance of funds of each group company, recorded in the received deposits table 16.

The interest is determine with reference to LIBOR (stands for London Interbank Offered Rate) for example. The LIBOR is a rate at which the banks borrow and lend a fund in London, the international financial market.

Also, each group company can borrow a fund from the funds concentration account 6 within its availability of credit preset for each of the group companies.

For this purpose, a negative balance is recorded in the balance record in a relevant area of the received deposits table and an allowable range of the negative balance is set depending upon the credit rating of each group company. The allowable range is recorded in a data base set in the storage unit, and the central controller monitors the allowable range so that the balance record in the received deposits table 16 will not exceed the range.

For example, it is assumed here that the company A wants to pay 40,000,000 yens to a payee from a fund in yens, the balance record in the yen area 21 of the company A is 10,000,000 yens and the allowable limit of the negative balance for the company A is 50,000,000 yens. In this case, since the fund in yens is short of 30,000,000 yens, the central controller controls the payment request reception unit 18 to update the balance record in the yen area 21 to −30,000,000 yens and the transfer data preparation unit 19 to prepare transfer data for remittance of 40,000,000 yens to the payee.

At this time, when the allowable range of the negative balance for the company A is 10,000,000 yens, the central controller will display an alarm on the display unit of the terminal unit at the company A and stop the remittance operation since the allowable limit will be exceeded if 30,000,000 yens are lent to the company A.

Also, when a group company has borrowed a money from the funds concentration account 6, it has to pay back the money along with a due interest to the funds concentration account 6 at the repayment of the borrowed money.

Also, the currency change unit 17 has functions to respond to a request from a group company to calculate a change between currency units and update the balance in the received deposits table 16.

When a group company wants to change its own fund from an amount in other currency unit, the person in charge of the company selects the item “change request” displayed, by the funds management system 8, on the menu screen on the display uni of its terminal unit. Then, the change request is sent to the funds management system 8. Receiving the change request, the funds management system 8 displays a change input screen on the display of the terminal unit at the group company.

The person in charge of the company enters necessary matters to the change input screen to prepare change data which will be described in more detail later. After preparing the change data, the person in charge sends it to the funds management system 8. The change data is received by the currency change unit 17 which will make a change calculation at a predetermined rate and update, by rewriting, the balance record in the received deposits table 16.

For example, it is assumed here that the company A wants to change a fund of 1,000,000 Euros to an amount in yens and that the currency change unit 17 will convert the fund at a rate of 100 yens/Euro, the currency change unit 17 rewrites the balance record in the Euro area 23 by subtracting 1,000,000 Euros from the balance record while rewriting the balance record in the yen area 21 by adding one billion yens to the balance, to thereby change the fund.

The managing company asks each group company for submitting a necessary amount of fund for payment and other purposes beforehand, and thus predicts necessary funds in yens, dollars and Euros for payment on a due date to know an exchange exposure. Securing the necessary amount of fund while dealing derivatives etc. to hedge against exchange risk, the managing company manages the funds in the funds concentration account 6 to increase them. That is, the managing company manages the funds in advance to prepare necessary funds for each group company for payment and other purposes in designated currencies as well as on a designated currency change date, while collectively hedging the funds pooled in the funds concentration account 6 in order to avoid any exchange risk.

For this reason, an exchange rate adopted for actual exchange made by a financial establishment under the request from the managing company differs from a one adopted by the currency change unit 17 (fixedly preset by the managing company) in some cases. When a profit takes place to the managing company from a difference between the exchange rates, the currency change unit 17 can return the profit to the group companies, which will be described in more detail later.

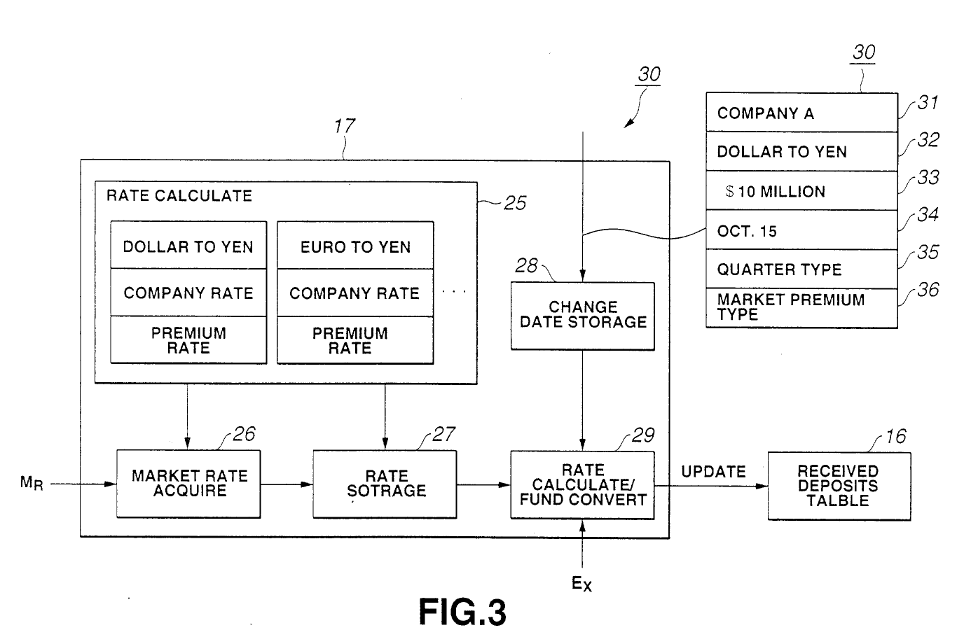

FIG. 3 is a block diagram of the currency change unit 17.

As shown, the currency change unit 17 includes a market rate acquiring unit 26 which monitors the spot rate, swap rate, forward rate, etc. in the foreign exchange market and records them into the data base.

The foreign exchange dealings include spot dealings, forward dealings, forward delivery, etc. The “sport dealing” is to make delivery within 2 days of business after a foreign exchange dealing. The rate used in the dealing is called “spot rate”.

The “forward delivery” and “forward dealing” are to make delivery after 3 days of business. In the forward delivery, those concerned can freely determine a date of delivery and money amount. The forward dealing is to make buy and sale in the market. The rate is called “forward rate”. The “swap rate” is a result of subtraction of a spot rate from a forward rate. In the actual interbank market, both the spot rate and swap rate are used for exchange.

The rates for exchange between currency units, adopted in the currency change unit 17, include two kinds: company rate and premium rate.

The above rates are calculated using predetermined formulae based on the market spot rate and swap rate, as will be described in mode detail later.

The currency change unit 17 further includes a rate calculation unit 25 which calculates, every moment, rates of exchange between currencies, such as a company rate and premium rate for currency change from dollar to yen, those for currency change from Euro to yen, etc. based on the market rate according to a rate calculation program.

The “company rate” is a rate applied uniformly to each of the group companies irrespectively of any fluctuation of the foreign exchange market rates as will further be described later. For example, it is assumed that the company A has subscribed for an exchange for yen buying and dollar selling at a company rate to the funds management system 8 in order to convert proceeds in dollars, to be paid in on a date after 3 months, into an amount in yens. If the company rate on that date 108 yens/dollar, the company A will change dollar to yen at the rate of 108 yens per dollar whether the market rate (spot rate) is 120 yens per dollar or 100 yens per dollar on the date of currency change after the 3 months.

Namely, the company A can secure a sale in foreign currency or the like in advance independently of any exchange fluctuation. An exchange risk is to be taken by the managing company which is managing the funds management system 8. An exchange loss due to a stronger yen and an interest due to a weaker yen in the foreign exchange market after the 3 months are both attributable to the managing company.

The “premium rate” is a lowest rate the managing company guarantees to each group company having applied for currency change independently of any fluctuations of rates, as will be described in mode detail later.

The premium rate has the convertible ratio set low so that the amount after changed at the premium rate is smaller than that changed at a company rate, for example, so that in the case of change from dollar to yen, the company rate is 105.20 yens/dollar while the premium rate is 104.44 yens/dollar. Instead, when the yen has become weaker while the dollar has become stronger at the time of change after the application for currency change, for example, when the rate has become 110 yens/dollar, the managing company has to return a constant proportion of a difference between 110 yens and 104.44 yens to the company A. Alternatively, when the managing company has hedged the rate by derivative dealings (forward dealing, option transaction, etc.), for example, when the hedged rate has changed for weaker yen and stronger dollar than those at the premium rate, like 108 yens/dollar, (namely, the hedged rate is better), the managing company has to return a constant proportion of a difference between 108 yens and 104.44 yens to the company A.

Also, independently of any rate worsening, for example, even with a rate of 90 yens/dollar, the managing company has to guarantee the premium rate, namely, 104.44 yens/dollar in this example, to the group company.

As above, the premium rate is the lowest guaranteed rate for the group companies. It may be said to be a cost rate worsened at a constant ratio (e.g., −0.5%), which is an optional charge incidental to the guaranty by the managing company of a premium rate to the group companies.

The above “cost rate” is a result of subtraction of a forward rate from a market rate, which is a rate targeted by a trader when hedging the rate.

The constant proportion of a difference between a premium rate and hedged rate, to be returned by the managing company to the group company, is also called “profit” as the case may be.

Each group company can select a company rate or a premium rate, set by the managing company.

That is, each group company can select the company rate to assure a sale in foreign currency or the premium rate, which is guaranteed lower, to take a chance to change a money at a rate which can be more profitable depending upon the movement of the market.

The currency change unit 17 further includes a rate storage unit 27 having a data base in which a company rate and premium rate calculated by the rate calculation unit 25, and a market rate M_{R}. The stored data is used for later calculation of a changed amount and updating of the received deposits table 16.

The currency change unit 17 further includes a currency change data storage unit 28 having a data base in which change data 30 sent from the terminal unit of each group company is stored. The change data 30 consists of company name data 31, conversion currency data 32, changed amount data 33, change date data 34, rate-application type data 35, and selected rate data 36.

The company name data 31 includes information for identification of a group company making a request for change. In the example shown in FIG. 3, the company A is making a request for change. The conversion currency data 32 includes information of a currency in which the change is to be made. In the example shown in FIG. 3, the company A is requesting a change from dollar to yen. The change amount data 33 includes information for identification of a conversion amount. In the example shown in FIG. 3, a request is made for change of 10,000,000 dollars to an amount in yens.

The change date data 34 includes information for identification of a due date for the change. In the example shown in FIG. 3, the change date is October 15.

The rate-application type data 35 includes information for identification of a rate-application type selected by the company A from rate-application types made available by the funds management system 8. As will be described later, the rate-application types include “monthly type” and “quarter type”, either of which the company A can be selected. The selected rate data 36 includes information for identification of a rate type having been selected by the company A from rate types made available by the funds management system 8. As will further be described later, the rate types include “company rate type”, “market rate type” and “hedged rate type”.

The currency change unit 17 further includes a rate calculation/fund conversion unit 29 which receives the currency change data 30 from the currency change data storage unit 28, a rate from the rate storage unit 27 and actual change rate Ex at which a change has been done actually in the market on the change date, from the banking system 2, to calculate a rate for a company having asked for a change according to a change calculation program. The rate calculation/fund conversionunit 29 updates, by increasing or decreasing, the balance record in the received deposits table 16 based on a calculated change rate.

A company rate is determined and applied in two types: quarter type and monthly type.

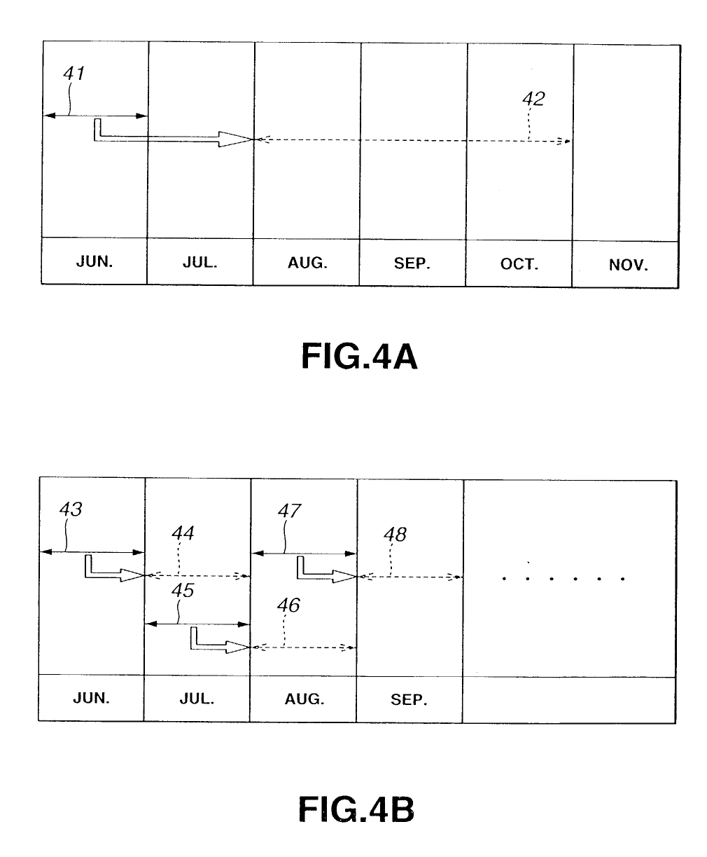

FIG. 4A shows the method of determining a quarter-type company rate, and a rate-applied term. The term for which the quarter-type company rate is applied is 3 months, and the value of the company rate is calculated based on a monthly mean value of a spot rate and swap rate in an intermediate month of a quarter term before the rate-applied month, that is, in a month 2 months before a month for which the company rate is applied.

A company rate 42 applied to a quarter term from July to September, for example, is calculated from a mean value 41 of the market rates in May. For a term from July to September, the company rate 42 is applied to a payment by the managing company of a bill a group company has received as a result of a business activity or to change of a settlement amount resulted from sale of a merchandise. Also, the group company can select the premium rate, which will be described in detail later.

The company rate is calculated using the following formula 1. Note that the formula 1 is stored in the storage unit and used for calculation of a company rate by the rate calculation unit 25 according to the rate calculation program.

(company rate)=(spot rate)×{1+(swap rate)−(charge)} (1)

In case the group company has selected to apply the company rate, a currency change for which a request had been made by a group company to the managing company in the quarter term or a currency change asked for in a payment request is effected at the company rate independently of any market rate fluctuation.

Also in case proceeds in a foreign currency, based on a contract concluded in this term, are to be paid in after the quarter term, the company rate for the quarter term is applied.

The company rate is renewed at every quarter periods.

FIG. 4B shows the method of determining a monthly-type company rate, and a rate-applied term. The monthly-type company rate is applied for one month, and calculated from a mean value of spot rates and swap rates in the month preceding the rate-applied term.

For example, a company rate 44 for July is calculated from a mean value 43 of the market rates in June using the formula (1). Similarly, a company rate 46 for August is calculated-from a mean value 45 of the market rates in July, and a company rate 48 for September is calculated from a mean value 47 of the market rates in August, using the formula (1) above, respectively.

A currency change form a payment to be done by the managing company for a group company, asked for in the term for which the company rate is applied, is calculated based on the company rate independently of any market rate fluctuation in case the group company hopes to make the currency change at the company rate.

Also in case proceeds in a foreign currency, based on a contract concluded in the term, are paid in after this month, the company rate for the month is applied.

The company rate is renewed monthly.

The derivative will be described herebelow. It is a scheme to hedge against a foreign currency risk.

Normally, settlement of the proceeds from the sale of a merchandise in dollars takes a predetermined length of time like 60 days. If the yen has become stronger than the dollar at the end of such a period, the proceeds received in yens will be decreased in value. To hedge against such a foreign exchange risk, it will be a solution to use the derivatives such as option, forward delivery, forward dealings.

The “option” is selling or buying of a right to sell or buy a fund in a predetermined currency unit at a preset rate on a predetermined date in future or in a period up to a predetermined date in future. The right to sell is called “put option” while the right to buy is called “call option”.

For example it is assumed here that a person A, who will be paid proceeds of 10,000 dollars on a predetermined date after 2 months, has bought, from the option market, a right to buy 10,000 dollars of yen at a rate of 100 yens/dollar on that predetermined date. The money the person A has paid to buy the right is called “premium”. If the yen has become stronger in the 2 months and the market rate has become 80 yens/dollar on the predetermined date, the person A changes 10,000 dollars to yens at a rate of 100 yens/dollar with taking advantage of the option. On the contrary, if the yen has become weaker and the market rate has become 110 yens/dollar on the predetermined date, the person A change 10,000 dollars to yens at the market rate without taking advantage of the option. In this case, the premium paid to buy the option will not be returned to the person A, but since the person A has paid the premium for the option, he can hedge against a risk that the exchange rate will move for stronger yen and proceeds in yens will be considerably reduced in value.

If it is necessary to make a settlement in dollars on a predetermined date in future, a foreign exchange risk can be avoided by buying the option for dollar buy yen selling.

The “future” is to subscribe for an exchange rate at a time in future. For example, in case a person B has subscribed, in the market, for a currency change of a fund of 10,000,000 dollars at a rate of 100 yens/dollar on a predetermined date after 2 months, the person B will change the fund of 10,000,000 dollars at the rate of 100 yens/dollar irrespectively of any market rate after the two months. By subscribing for a future exchange rate as above, it is possible to assure proceeds to be settled in 2 months independently of any fluctuations in exchange.

The “forward delivery” is to subscribe for a exchange rate individually, not in the market.

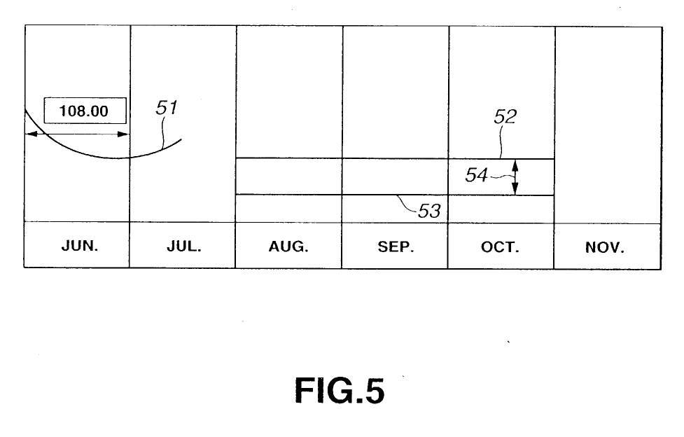

FIG. 5 explains the premium rate. As shown, the rate application type is the quarter type, and a fund in dollars is changed to yens at an exchange rate.

A company rate 52 for a quarter term from July to September is calculated based on a mean value of the market rates in May (108.00 yens, in the embodiment) using the above formula (1).

In the funds management system 8, the currency change unit 17 prepares a premium rate 53 in addition to the company rate 52. The premium rate 53 is calculated using the following formula (2) and set for the yen to be stronger by a premium 54 than at the company rate 52. That is, the premium rate 53 is unfavorable in ratio of conversion from dollar to yen to a group company going to change dollars to yens in comparison with the company rate 52.

The premium rate 53 is calculated using the following formula (2). The spread in the formula (2) is a rate down from the company rate. Note that the formula (2) is stored in the storage unit, and used by the rate calculation unit 25 in making a calculation according to the rate calculation program.

(Premium rate)=(spot rate)×{1+(swap rate)−(charge)+(spread)} (2)

When asking the managing company for currency change of a fund in dollars to a one in yens, the group company can select either the company rate 52 or premium rate 53 for application to the currency change. In case the group company selects the company rate 52, the currency change unit 17 will make a calculation for currency unit conversion at the company rate 52 independently of any foreign exchange fluctuations.

However, if the group company selects the premium rate 53 for the intended currency change, it will be possible depending upon the movement of the currency change market that a currency unit conversion at a rate more favorable than the premium rate 53 is available for the group company.

That is, if the managing company can have made the currency change at a more favorable rate than the premium rate 53 in the market on the date of currency change, the group company can have a return of a part of the exchange profit.

If the managing company has made the currency change at a more unfavorable rate than the premium rate 53, the group company will have its fund changed at the premium rate 53 by the managing company and the managing company will bear an exchange loss.

The premium 54 being a difference between the company rate 52 and the premium rate 53 corresponds to a premium in the option exchange. Namely, with the premium rate 53 selected, the group company will take a risk of a currency change at a more unfavorable rate than the company rate 52 but will get a right to have a part of a possible exchange profit when the managing company can have made a currency change at a more favorable rate than the premium rate 53 in the foreign exchange.

Note that the formulae for calculation of the company rate and premium rate are no limited to the formulae (1) and (2) but may be appropriately set correspondingly to the situations within the company group.

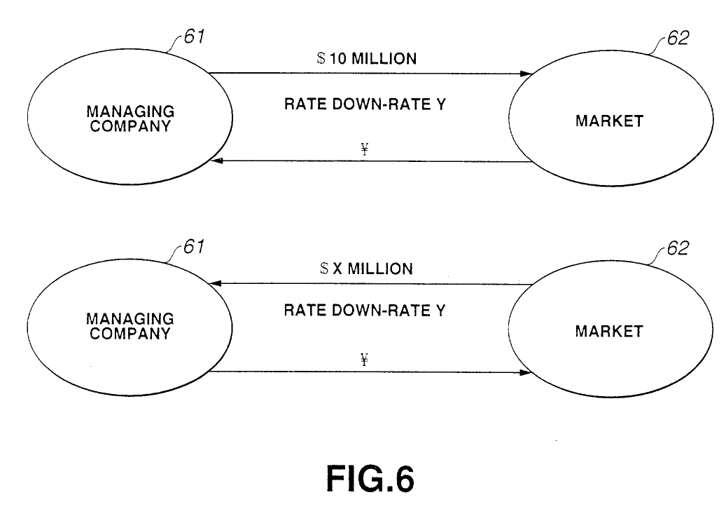

FIG. 6 explains the setting standard for the premium 54.

In this embodiment, the managing company uses the option pricing model to set the premium for the expected value of a profit to be zero when a premium rate is selected. Namely, the managing company sets the premium so that the expected value of a profit coming from a currency change in the market at a more favorable rate than the premium rate will be equal to that of a loss coming from a currency change in the market at a more unfavorable rate than the premium rate.

Assume that a managing company 61 buys an option for dollar buying and yen buying of 10×1,000,000 dollars and the rate down-rate is as −Y and the rate down-rate of an option for dollar buying and yen selling of X×1,000,000 dollars is −Y. When the premium 54 is set as (10−X)/10, the option pricing model leads the economic effect of the currency changing service by the managing company 61 for the group companies to be neutral to the managing country 61.

When the group company selects the premium rate, there are available two types of exchange profit return systems: market rate type and hedged rate type.

The “market rate type” system is such that a premium rate and market rate, prevalent on a date when the managing company has been requested from the group company to make a payment for settlement or to make a currency change, are compared with each other to find a difference between them, and a constant proportion, 50%, for example, of the difference between the market rate and premium rate is returned to the group company when the market rate is more advantageous than the premium rate.

The “hedged rate type” system is such that a premium rate and a rate hedged by the managing company using derivatives, prevalent on a date when the managing company has been requested from the group company to make a payment for settlement or to make a currency change, are compared with each other to find a difference between them, and a constant proportion, 50%, for example, of the difference between the hedged rate and premium rate is returned to the group company when the hedged rate is more advantageous than the premium rate.

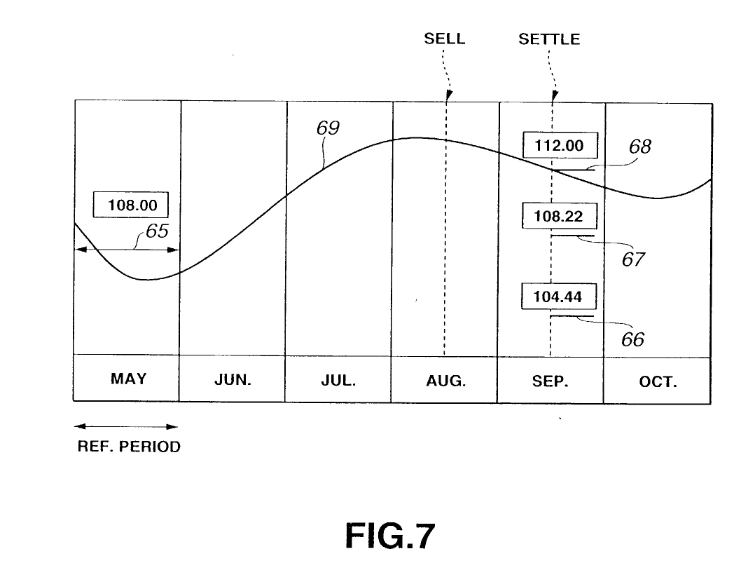

FIG. 7 shows an example of the exchange profit return in the market rate type system.

Assume here that a company A has sold a merchandise in dollars on August 15 and the proceeds from the sale have to be settled on September 15, and that the company A has selected a quarter type for a rate-applied term from July to September as a rate application type of the currency change and a market rate type as a rate type. In this case, the premium rate for the quarter term is calculated from a mean value 65 of the market rates in May. In this example shown in FIG. 7, the mean value 65 is 108.00 yens and the company rate will be obtained by adding or subtracting a swap rate being a forward dealing cost to or from the market rate and subtracting a service charge as a running cost the funds concentration system 8 from the result of the addition or subtraction as shown by the formula (1). Note that the swap rate is determined with reference to the aforementioned LIBOR. An other index may be used for determining the swap rate. The premium rate will be a result of subtraction of a premium as a spread from the company rate, as shown by the formula (2). The premium rate is 104.44 yens in the example shown in FIG. 7. In FIG. 7, a curve 69 indicates a transition of the market rate for yen buying and dollar selling (spot rate). In case a market rate 68 when the managing company has made a currency change of a fund in dollars to a one in yens in the market on the date of settlement (as above, since the spot rate is a rate for a one to be delivered within 2 business days after exchange transaction, it is actually a spot rate 2 business days before the settlement date) is 112.00 yens, the company A will have a return of 50% of 7.56 yens being a difference between the market rate 68 and premium rate 66 as an exchange profit 67 and can have the managing company make a currency change of the return at a rate of 108.22 yens per dollar.

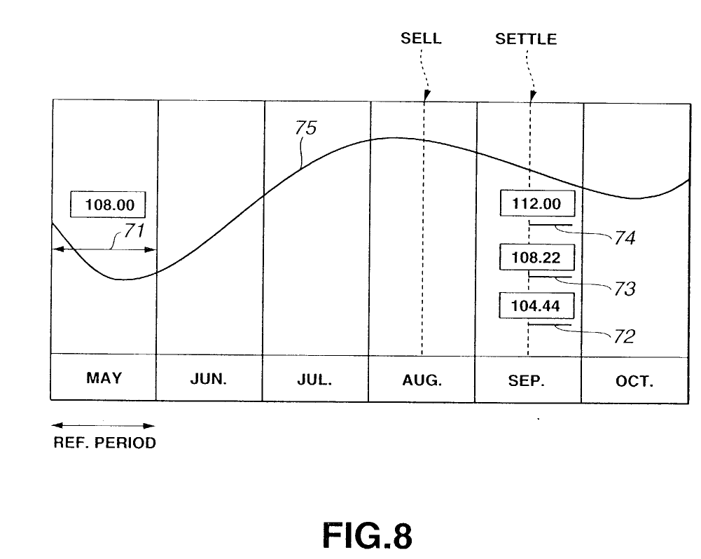

FIG. 8 shows an example of the exchange profit return in the hedge rate type system.

Assume here that the company A has sold a merchandise in dollars on August 15 and the proceeds from the sale have to be settled on September 15, and that the company A has selected a quarter type for a rate-applied term from July to September as a rate application type of the currency change and a hedged rate type as a rate type. In this case, the company rate in the quarter term depends on a mean value 71 of the market rates in May and the premium rate 72 for the quarter term is calculated from the company rate. In this example shown in FIG. 8, the mean value 71 is 108.00 yens and the premium rate 72 is 104.44 yens. In FIG. 8, a curve 75 indicates a transition of the market rate for yen buying and dollar selling. Watching the market movement, the managing company hedges the rate when appropriate. Therefore, the hedged rate is a result of subtraction of the aforementioned forward dealing cost from the weighted average of the hedging made by the managing company by a date 2 days of business before the actual settlement from the reference month (a mean value of amount of currency by individual hedge rate). In the example in FIG. 8, when a hedged rate 74 on the date of settlement (actually, 2 business days before the settlement date) is 112.00 yens, the company A will have a return of 50% of 7.56 yens being a difference between the hedged rate 74 and premium rate 72 as an exchange profit 73 and can have the managing company make a currency change of the return at a rate of 108.52 yens per dollar.

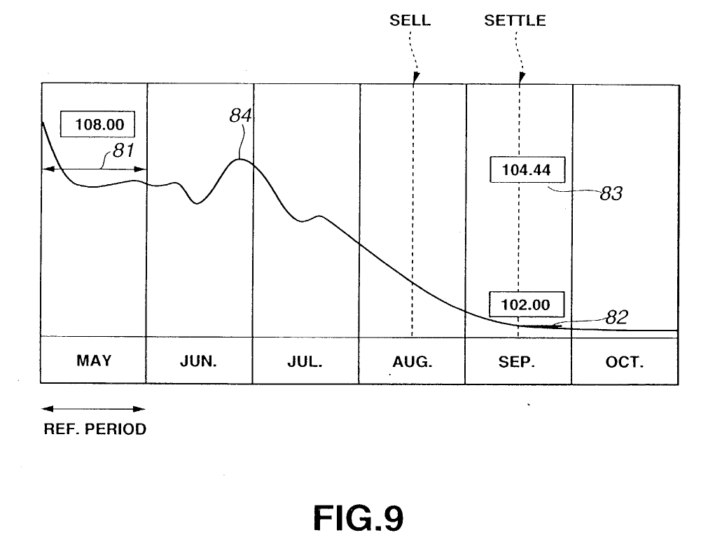

FIG. 9 shows that a market rate 82 is lower than a rate 83 at a premium on the date of settlement in the market rate type system.

Assume here that the company A has sold a merchandise in dollars on August 15 and the proceeds from the sale have to be settled on September 15, and that the company A has selected a quarter type for a rate-applied term from July to September as a rate application type of the currency change and a market rate type as a rate type. In this case, the company rate in the quarter term depends on a mean value 81 of the market rates in July and the rate 83 at a premium for the quarter term is calculated from the company rate. In this example shown in FIG. 9, the mean value 81 is 108.00 yens and the rate 83 at a premium is 104.44 yens. A curve 84 indicates transition of a market rate for yen buying and dollar selling.

If the market rate 82 is lower than the rate 83 at a premium on the date of settlement, the managing company will guarantee the group company A for the rate 83 at a premium and will bear a loss due to a difference between the rate 83 at a premium and market rate 82.

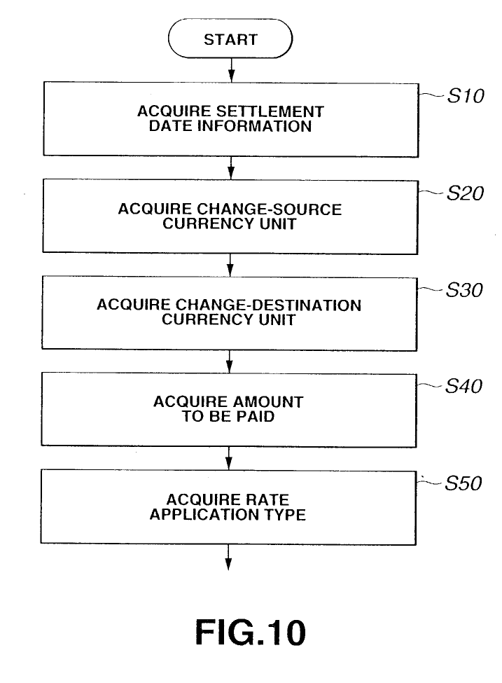

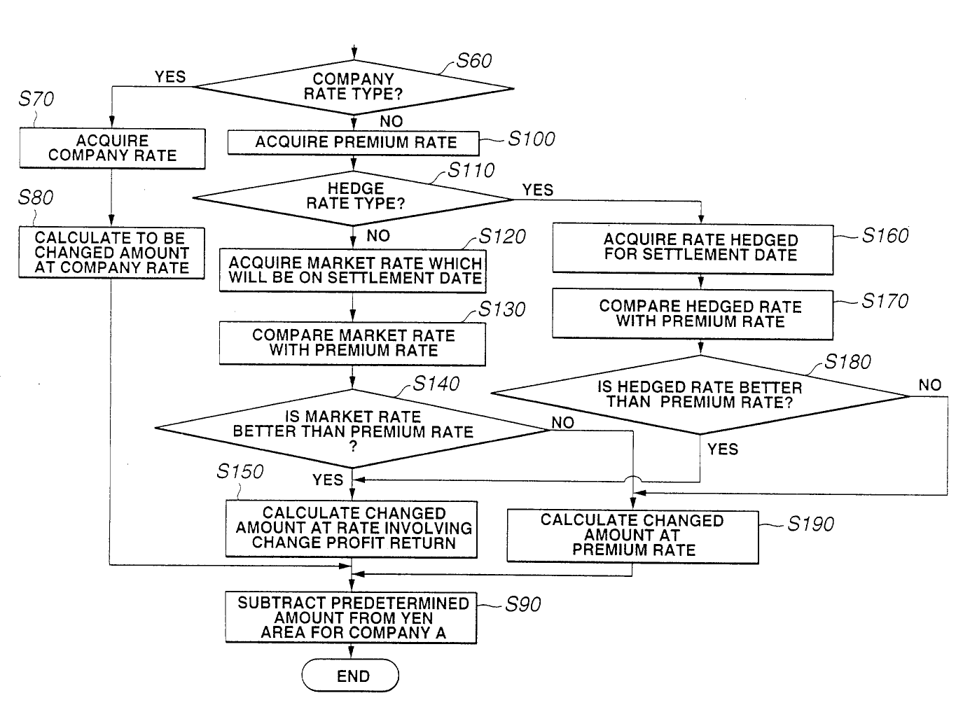

FIG. 10 shows a flow of operations made by the currency change unit 17 when the funds concentration system 8 is given from the company A directions for converting a fund in yens into an amount in dollars for payment to the payee company.

In this example, the company A selects, by means of the funds concentration system 8, the item “pay to ex-group company” from the menu screen displayed on the display unit of its terminal unit. Then, the funds concentration system 8 will display an ex-group payment screen on the display unit. The person in charge of the group company enters necessary matters to the ex-group payment screen to prepare ex-group payment request data and sends it to the funds concentration system 8. Receiving the ex-group payment request data, the central controller of the funds concentration system 8 determines that it is necessary to make a currency change for the ex-group payment. Then, the central controller prepares currency change data 30 from the ex-group payment request data, and sends it to the currency change unit 17.

Receiving the currency change data 30 from the central controller, the currency change unit 17 follows the procedure described below to acquire various data and store them into the RAM or storage unit.

First in step S10, the currency change unit 17 acquires information on the date of settlement from the currency change data 30 to determine whether there is a return of an exchange profit on the date of settlement.

Next in step S20, the currency change unit 17 acquires a currency unit of a fund to be changed from the currency change data 30. In step S30, the currency change unit 17 acquires a unit of payment currency, namely, a unit of a currency of a changed fund. In this example, to change a fund in yens to a one in dollars for payment to the payee, the currency unit of the fund to be changed is yen and the currency unit of the fund changed is dollar.

Next in step S40, the currency change unit 17 acquires a money amount to be paid to the payee from the currency change data 30. In this example, in case the money is to be paid in dollars, the amount is 1,000,000 dollars, for example.

Then, the currency change unit 17 acquires a rate application type from the currency change data 30. The rate application types includes a monthly type and a quarter type. In this example, it is assumed that the company A has selected the quarter type. The information is stored into the currency change data storage unit 28.

Next, the currency change unit 17 determines based on the currency change data 30 whether the rate type is a company rate type, hedged rate type or market rate type. When the rate type is the company rate type (YES in step S60), the currency change unit 17 goes to step S70 where a company rate will be calculated by the rate calculation unit 25 and a company rate stored in the rate storage unit 27 be read into the rate calculation/fund conversionunit 29.

In step S80, the rate calculation/fund conversionunit 29 further acquires a amount of payment, unit of payment currency and currency unit of a fund to be changed from the currency change data storage unit 28, and converts a conversion amount at the company rate.

In this example, since 1,000,000 dollars is paid, the company rate is made 100 yens/dollar and thus the conversion amount is one billion yens.

Next, the rate calculation/fund conversionunit 29 updates the received deposits table 16 by subtracting the conversion amount, one billion yens in this example, from an area for fund balance in yens of a section for the company A of the received deposits table 16.

In case the company A has selected either the hedged rate type or market rate type (NO in step S60), the rate calculation/fund conversionunit 29 goes to step S100 where it will acquire, from the rate storage unit 27, a premium rate to be applied on the date of settlement.

Next in step S110, the rate calculation/fund conversionunit 29 determines which the rate type is, the hedged rate type or market rate type. When the rate type is the market type (NO in step S110), the currency change unit 17 goes to step S120 where the rate calculation/fund conversionunit 29 will acquire, from a bank 2, a market rate which will be when the banking establishment changes a fund in yens in the funds concentration account 6 to a one in dollars actually on the date of settlement (actually, 2 days of business from the date of settlement).

In step S130, the rate calculation/fund conversionunit 29 compares the market rate with the premium rate.

If the result of comparison shows that the market rate is more favorable than the premium rate (YES in step S140), the currency change unit 17 goes to step S150 where the rate calculation/fund conversionunit 29 will calculate a conversion amount at a rate resulted from addition, to the premium rate, of a constant proportion of a difference between the market rate and premium rate, 50% for example.

When the premium rate is more favorable than the market rate (NO in step S140), the currency change unit 17 goes step S190 where it will calculate the conversion amount at the premium rate.

Next, the rate calculation/fund conversionunit 29 updates the received deposits table 16 by subtracting, from the area for fund balance in yens in the section for the company A in the received deposits table 16, the conversion amount, namely, one billion yens, when a money of one billion yens is changed at a rate of 100 yens/dollar for example,

When the company A has selected the hedged rate (YES in step S110), the currency change unit 17 goes to step S160 where the rate calculation/fund conversionunit 29 will acquire a rate hedged by using derivatives when the managing company has changed a fund in yens in the funds concentration account 6 to an amount in dollars by 2 business days before a period from the reference date until the settlement date.

Next in step S170, the rate calculation/fund conversionunit 29 takes a result of subtraction of a forward dealing cost from hedged data as a hedged rate and compares it with the premium rate.

If the result of comparison shows that the hedged rate is more favorable than the premium rate (YES in step S180), the currency change unit 17 goes to step S150 where the rate calculation/fund conversionunit 29 will calculate the conversion amount at a rate resulted from addition of a constant proportion of a difference between the hedged rate and premium rate, 50% for example, to the premium rate.

When the premium rate is more favorable than the market rate (NO in step S180), the currency change unit 17 goes to step S190 where the rate calculation/fund conversionunit 29 will calculate the conversion amount at the premium rate.

Next, the rate calculation/fund conversionunit 29 updates the received deposits table 16 by subtracting, from the area for fund balance in yens in the section for the company A in the received deposits table 16, the conversion amount, namely, one billion yens, when a money of one billion yens is converted at a rate of 100 yens/dollar for example,

The funds concentration system constructed as above permits to make it unnecessary to pay bank-account transfer service charges and make transactions for the bank-account transfer in the settlement inside the company group. Further, the funds concentration system 8 provides such a scheme that each group company can put the managing company into charge of the foreign exchange services which require profound knowledge and experiences and which will largely affect the financial state of the group company and can have a return of a part of an exchange profit, if resulted, from the on-market foreign exchange and currency change made by the managing company for each group company. Thus, each of the group companies participating in the funds concentration system can have a large profit, which will be an incentive to encourage other group companies to take part in the funds concentration system.

In the above embodiment, the managing company and bank are separate from each other, to which the present invention is not limited. For example, the funds management system 8 may be installed in a bank, the bank itself may be constructed to have the same functions as those of the managing company, or the funds concentration account 6 may be located in the bank for the managing company to make direct transactions with the financial markets such as the foreign exchange market and derivatives market, not through the banking establishment.

Also, in the embodiment, the group company selects the market rate type or hedged rate type beforehand, to which the present invention is not limited. The managing company may determine whichever is more advantageous, the market rate type or hedged rate type, for the group company and apply a more favorable rate type.

Note that the “managing company” referred to herein is one of the companies belong to a company group and includes a company or bank, which collectively makes currency change services for the group companies.

Further, the “group company” referred to herein is each of companies having certain financed relation and contracted relation with each other.

Also, in this embodiment, even when the group company ha selected a premium rate, the rate is shifted to a market rate or hedged data which is more favorable than the selected premium rate. However, when a payment request is made from a group company, an payment amount calculated at a premium rate may be subtracted from the received deposits table for the group company, and only when a market rate or hedged rate is more favorable than the premium rate on a date of settlement, a difference between the market rate or hedged rate and the premium rate may be returned to the received deposits table for the group company, namely, a profit may be returned to the group company.

Furthermore, in the aforementioned embodiment of the present invention, each of the group companies provides a necessary amount of fund for payment and other purposes and the managing company detects an exchange exposure based on the fund. However, for the managing company to detect an amount of currency to be hedged as accurately as possible without any difference between the detected exchange exposure and actual exchange amount, the currency amount to which the premium rate may be limited to a constant error range for an amount of fund having been provided by each group company and an actual market rate be applied to a part of the currency amount, beyond the error range.

Also, in the embodiment, the group company selects either a company rate or a premium rate. Alternately, the rate applied to a currency change for the group company may be limited only to the premium rate, and when the managing company has gained a foreign exchange profit, a part of the profit may be returned to the group company.

Further, the funds concentration system according to the present invention nay be constructed as a variant as follows.

The variant is a computer-supported system for collective management of funds and financial information of multiple companies belonging to a group, including:

means for managing, for multiple kinds of currency units, funds and financial information of the multiple group companies by a concentration account being a single account used for in-payment and payment for each of the multiple group companies and a virtual account virtually provided, for each of the group companies, in a data base file based on which the breakdown of the concentration account;

means for making a settlement by the concentration account by converting payment plan information of each group company into a uniform format and making a collective settlement for the group company, by a bank in which the concentration account is placed, based on the payment plan information converted in the uniform format;

means for moving an in-payment amount in a settlement account of the group company to the concentration account, acquiring a specification of the in-payment amount moved to the concentration account and updating the history of transactions having been made by the group company and the breakdown of the virtual account in the data base file;

means for registering a specification data on payment from the group company to any other group company, converting the payment specification data into a uniform format, and updating, based on the payment specification data, the data on the history of transactions of the group company and other group companies;

means for registering interest data and credit frame data on the group companies;

means for extracting in-payment to each group company, scheduled payment date and daily balance data of the group company and outputting, by calculation, a future in-payment, payment and cumulative balance;

means for extracting balance in the concentration account, in-payment and payment specification data on the group companies to predict a surplus or deficit in the concentration account;

means for registering a specification data on account receivable the group company to any other group company, converting the account-receivable specification data into a uniform format, checking the account-receivable specification data by any other group companies, additionally registering payment confirmation data, and updating, based on the payment confirmation data, the data on the history of transactions of the other group companies;

means for registering specification data on account receivable the group companies have to any third party, converting the account-receivable specification data into a uniform format, inquiring the account-receivable specification data by the third party, additionally registering payment confirmation data, extracting the payment conformation data by a company finance center or bank over a network while acquiring in-payment specification of each group company via a firm banking service, collating the payment specification data and in-payment specification for each payer and money amount, and adding the in-payment confirmation data to the payment confirmation data which can have been collated; and

means for access control and input/output encoding by log-in password, screen move password and authorization password.

Further, in this embodiment, the group is composed of the group companies 7a, 7b, . . . , to which the present invention is not limited. The present invention is applicable to a relation between a general bank and its customers. Also, the customers may be a group of companies (having some financed and contracted relations with each other) or a single company.

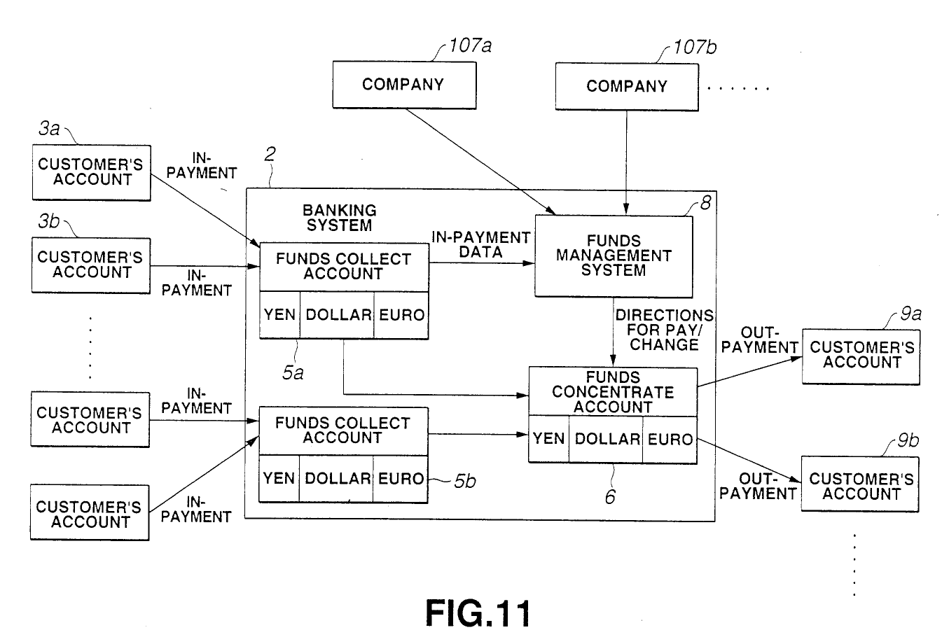

FIG. 11 is a block diagram showing an example of the banking system showing relations among banking systems 102, companies 107a, 107b,. . . . The banking system 102 is a server computer installed in a bank or the like, and incorporates the funds management system 8. In this system, the services made by the managing company in the aforementioned embodiment will be done by a bank in this embodiment.

For example, the company 107a requests its customer for transferring proceeds into the funds collection account 5a in advance similarly to the company 7a in the aforementioned embodiment. A funds transferred into the funds collection account 5a is sent to the funds concentration account 6 on the same day and pooled in the account 6.

Also, the company 107a may request the banking system 102 for transferring a money in a designated currency unit to the customer's account 9a on a designated date.

The companies 107a, 107b, . . . will estimate in-payment from their customers and out-payment to their customers in advance, and notify the banking system 102 of the data.

Thus, the companies 107a, 107b, . . . can have the similar profits to those received by the group companies 7a, 7b, in the aforementioned embodiment.

More specifically, the companies 107a, 107b, . . . can select either a company rate or premium rate when making a request for currency change to the banking system 102, and expect a profit return when they have selected the premium rate. Further, the premium rate includes two types: a market rate type which determines an amount of profit return based on a market rate, and a hedged rate type which determines an amount of profit return based on a hedged rate. When selecting a premium rate, the companies 107a, 107b, . . . can further select either the market rate type or hedged rate type of the premium rate, which is the same as in the funds concentration system 1 shown in FIG. 1.

Note that since the companies 107, 107b, . . . are not any group company, a rate corresponding to the company rate will be referred to as “customer rate” hereunder.

As above, the present invention can be embodied for a company group including a managing company as well as for a general bank and its customers.

Next, a variant of this embodiment will be explained herebelow.

Generally, currencies in which the managing company is requested by the group company or the like to make a currency change, include for example local currencies of which the international circulation is relatively small, such as Thai baht, won of Korea, etc. in addition to the currencies circulating widely over the world, such as yen, dollar and Euro.

There many kinds of currencies used over the world, and any of them can possibly be used in the international commercial transactions. However, it will not be efficient to hedge each combination of these local currencies against any exchange risk. Since the circulation of them is relatively small, the service charges for hedging the exchange risk for them will be relatively high. With this variant of the banking system, however, many combinations of currencies can efficiently be hedged against exchange risk while a profit return owing to the hedging can be assured to the customers.

Note that this variant of the banking system can be used in both the system oriented to the group companies (shown in FIG. 1) and system oriented to the general banks and their customers (shown in FIG. 11) but the application of the banking system to the latter system will be illustrated and described herebelow.

The description will be started with a scheme of the currency change adopted in this variant.

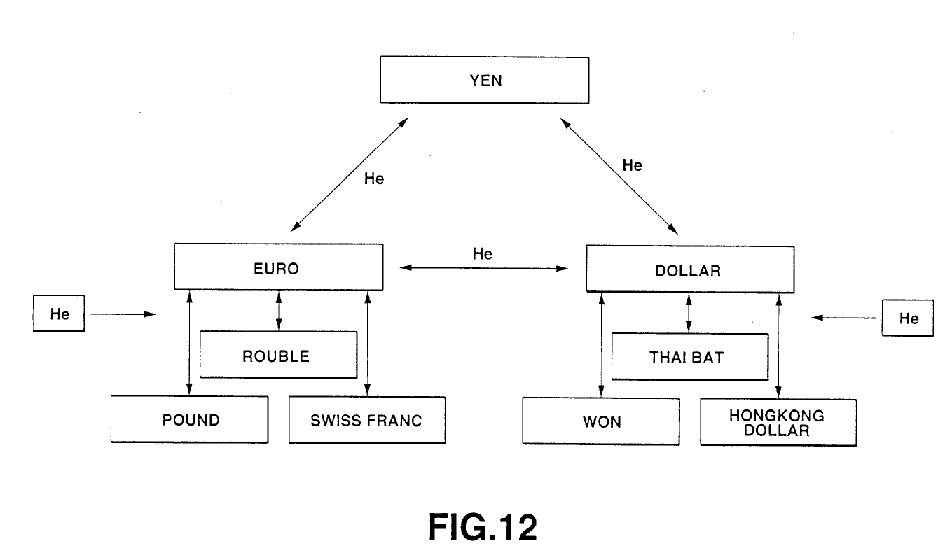

FIG. 12 explains the basic concept of the currency change conducted in this variant.

In this system, the currencies are classified into some basic ones (will be referred to as “base currency” hereunder) and other ones (will be referred to as “subordinate currency” hereunder) in combination with the base currency.

For example, the dollar, Euro and yen are taken as the base currencies for the convenience of the illustration and description. By taking, as the base currencies, the ones most widely used in the international commercial transactions, it will be easy to hedge the currencies against the exchange risk.

Also, the currencies such as pound, rouble, Swiss franc, etc. are taken as subordinate currencies of the Euro, for example, while the currencies such as won, Thai baht, Hongkong dollar, etc. are taken as subordinate currencies of the dollar. Any of the subordinate currencies may be selected for a business made in a district where it is circulated, or from any arbitrary viewpoint such as the convenience of currency change and services.

In FIG. 12, there is not shown any subordinate currency of the yen, to which the present invention is not limited. A currency may be taken as a subordinate currency of the yen.

In this system, for change of a fund in a subordinate currency to a one in another subordinate currency, the funds in the subordinate currencies are converted once into ones in the base currencies of the subordinate currencies and then a change is made between the amounts in the base currencies.

For example, for change of pound to Thai baht, the pound is first converted to Euro, the base currency of the pound. On the other hand, the Thai baht is converted into dollar, the base currency of the Thai baht, and then a conversion is made between the dollar and Euro.

That is, on the assumption that the conversion from a currency A into a currency B is depicted by A→B, the conversion from pound into Thai baht will be depicted by conversions like pound→Euro and Thai baht→dollar and by a further conversion like Euro→dollar as will be seen in FIG. 12. Namely, a typological conversion style of pound→Euro→dollar→Thai baht is attained. A conversion including further conversions will be referred to as “partial change(indirect conversion)” hereinbelow.

Note that the trader does not convert the Euro itself into which the pound has been converted into the dollar as above but he or she hedges the exchange rate by dealing the currencies such as dollar, Euro and other currencies as a whole pooled in a funds concentration account 106 which will be described in detail later.

Also, a conversion between subordinate currencies whose base currencies are the same one is effected via a conversion between their base currencies.

For example, for conversion between pound and rouble, the pound is first converted into Euro as its base currency, and then the Euro is converted into rouble.

By setting such base currencies and their subordinate currencies, it is possible to greatly reduce the number of combinations of currencies the trader has to hedge against exchange risk.

Namely, the trader has not to hedge a combination of pound and won, and a one of rouble and pound, against exchange risk, for example, but it will be sufficient that he should hedge only a combination of base currencies and a combination of a base currency and a subordinate currency against exchange risk.

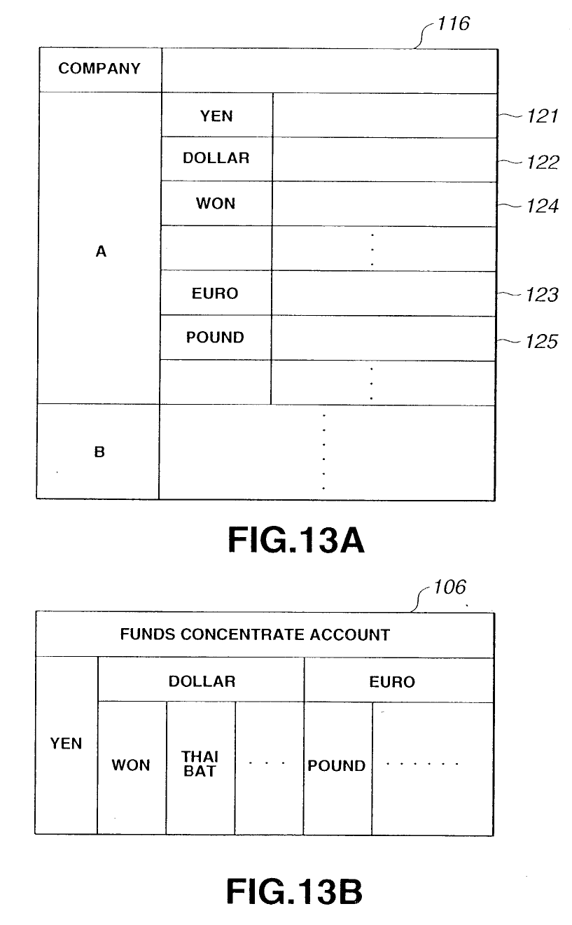

FIGS. 13A and 13B show a received deposits table 116 and a funds concentration account 106, respectively.

The received deposits table 116 and funds concentration account 106 correspond to the received deposits table 16 shown in FIG. 2 and funds concentration account 6 shown in FIG. 1, respectively, and they have the same functions except for the increased number of currency kinds to deal.

In this system, the received deposits table 16 and funds concentration account 6 in FIG. 11 are replaced by the received deposits table 116 and funds concentration account 106, respectively, and the logic for the partial change (indirect conversion) is additionally provided.

The received deposits table 116 shown in FIG. 13A is similar to the received deposits table 16 except for areas for other currencies such as won, pound, etc. possibly dealt by the companies 107a, 107b, . . . in addition to the currency areas for yen, dollar and Euro. The companies 107a, 107b, . . . can check the balance in the received deposits table 116 by watching the display unit on its terminal unit to known how many currencies they are currently holding.

The funds concentration account 106 shown in FIG. 13B is similar to the funds concentration account 6 except for balances of the subordinate currencies such as won, pound, etc. in addition to balances of the base currencies such as yen, dollar and Euro.

The band requests the companies 107a, 107b, . . . to submit their in-payment and out-payment schedules, and the trader hedges the funds pooled in the funds concentration account 106 based on the data by dealing the derivatives, etc. The funds are hedged for the currency change between the base currencies or between a base currency and subordinate currency.

The profit return scheme in this embodiment is also similar to that in the aforementioned embodiment. For example, a company 107a, wanting to convert a fund in Thai bahts to a money in pounds for payment in a half year, can select either a customer rate (corresponding to the company rate in the funds concentration system 1 in FIG. 1) or a premium rate as a currency change rate for the conversion from Thai baht to pound.

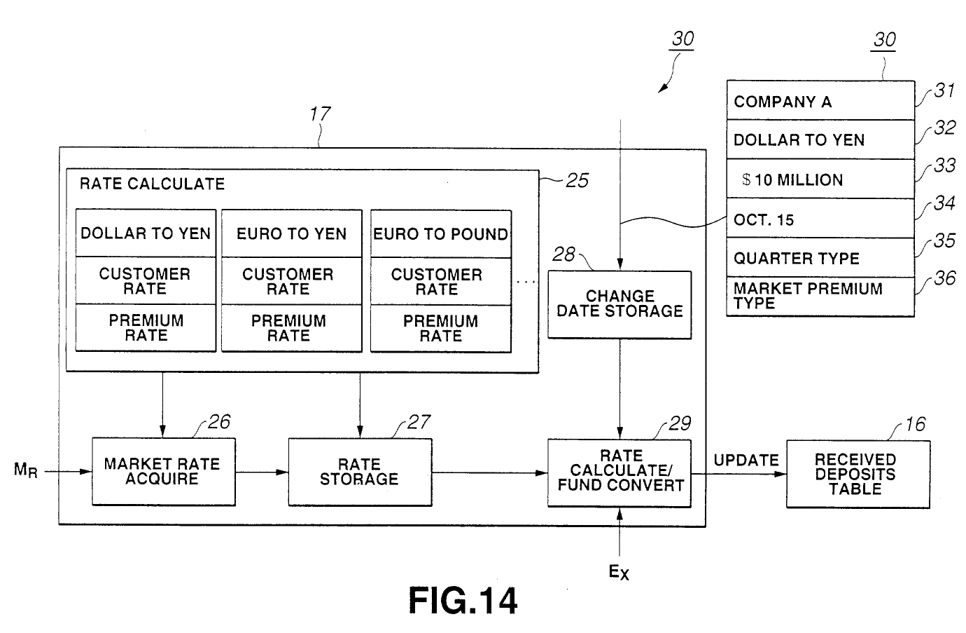

These rates have been calculated by a rate calculation unit 25 and rate calculation/fund conversionunit 29 (in FIG. 14), which will be described in detail later, based on a rate for conversion between Thai baht and dollar, a one for conversion between dollar and Euro and a one for conversion between Euro and pound.

As in the funds concentration system 1 shown in FIG. 1, the convertible ratio for the premium rate is set low compared to the customer rate and a profit return can be expected when the premium rate is selected. Also, the premium rate includes a market rate type and hedged rate type as in the funds concentration system 1.

FIG. 14 is a block diagram showing another example of the currency change unit 17, intended for the partial change (indirect conversion).

The currency change unit 17 calculates for example a customer rate for a conversion between a base currency and subordinate currency, such as Euro an pound, in addition to the customer rate and premium rate for a conversion between base currencies such as yen and Euro, for example.

These calculated data are stored in a rate storage unit 27.

A rate calculation/fund conversionunit 29 determines, based on conversion currency data 32 in the currency change data 30 stored in a currency data storage unit 28, whether the partial change (indirect conversion) is required or not. When no partial change is required, a currency change is effected at a currency change rate as in the aforementioned embodiment.

In case a partial change (indirect conversion) is necessary, a currency change rate is calculated based on a combination of a currency change rate for conversion between base currencies (customer rate and premium rate) and a one for conversion between a base currency and subordinate currency, stored in the rate storage unit 27.

For example, when the conversion currency data 32 is a one for a conversion from pound to Thai baht, the rate calculation/fund conversionunit 29 determines that a partial change (indirect conversion) is required.

Since the base currency of pound is Euro and that of Thai baht is dollar, the rate calculation/fund conversionunit 29 will acquire a rate for conversion between pound and Euro, a one for conversion between Thai baht and dollar, a one for conversion between Euro and dollar, and calculates an appropriate currency change rate for the customer based on these acquired rates, and a current market rate for conversion between pound and Euro, a one for conversion between Thai baht and dollar and a one for conversion between Euro and dollar, stored in the rate storage unit 27.

Note that the rate calculation unit 17 will calculate a rate for conversion between subordinate currencies, such as yen and pound, or for conversion between a subordinate currency and a base currency to which no currency is subordinate, for example, as the case may be.

Any combination of currencies for which a rate is to be calculated may be selected flexibly correspondingly to an intended business.

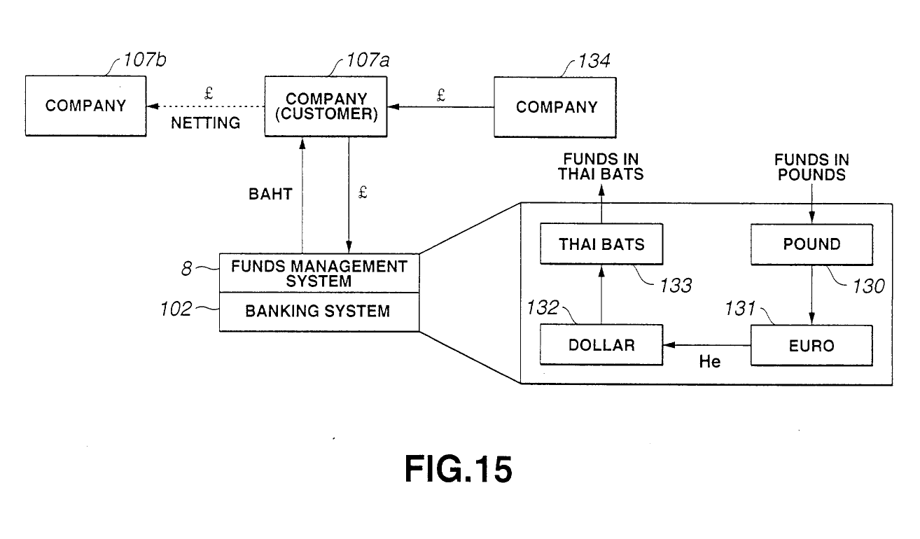

FIG. 15 shows a concrete example of a currency change between subordinate currencies.

Assume here that the company 107a receives proceeds in pounds from a customer 134 in 6 months. On the other hand, it is assumed that the accounting currency of the company 107a is Thai baht. The company 107a will send information on the schedule of in-payment of the proceeds in pounds to the funds collection account 5a after 6 months and a request for conversion of the proceeds to a money in Thai bahts to the funds concentration system 8 of the banking system 102 in advance.

In this case, since the base currency of Thai baht is dollar and that of pound is Euro, the currency change unit 17 will adopt the partial change (indirect conversion) to calculate a customer rate and a premium rate. Then, the company 107a can select either the customer rate and premium rate. When selecting the premium rate, the company 107a can further select either the market rate type or hedged rate type.

When the proceeds in pounds is paid into the funds collection account 5a from the company 134 in 6 months, a money converted at the customer rate will be added to the Thai baht area for the company 107a in the received deposits table 116 if the company 107a has selected the customer rate, or a money being an addition of the proceeds converted at the premium rate and a profit return will be added to the Thai baht area for the company 107a in the received deposits table 116 if the company 107a has selected the premium rate.

The banking system 102 will hedge funds of which the currency change ha been requested from other companies 107b, 107c, . . . , a fund in pounds 130 for conversion to a money in Euro 131, a fund in Euro 131 for conversion to a money in dollars 132, and a fund in dollars 132 for conversion to a money in Thai bahts 133.

Also, the banking system 102 has a netting function.

For example, assume that the company 134 is going to pay 100,000 pounds to the company 107a in 2 months, and that the company 107a is planned to pay 50,000 pounds to the company 107b being the customer of the same banking system 102 in 2 months. In this case, the payment money of 50,000 pounds to the company 107b will be settled by the money of 100,000 pounds transferred from the company 134 to the account of the company 107a in the banking system 102.

Namely, when the 100,000 pounds has been paid rom the company 134, 50,000 pounds can be added to the pound area for the company 107b while 50,000 pounds can be added to the pound area for the company 107a, for the above settlement. Also, when the company 107a wants to have the proceeds from the company 134 changed to a money in Thai bahts, the 50,000 pounds may be converted to Thai baht at one of the customer rate or premium rate, selected by the company 107a and the money thus converted may be added to the Thai baht area for the company 107a.

Thus, a netting can be done without movement of any fund by rewriting the data in the received deposits table 116.

By the netting, it is possible to minimize any exchange risk.

The funds management system 8 has a netting unit (not shown) and is always detecting an opportunity of netting based on in-payment and out-payment schedules of the customer.

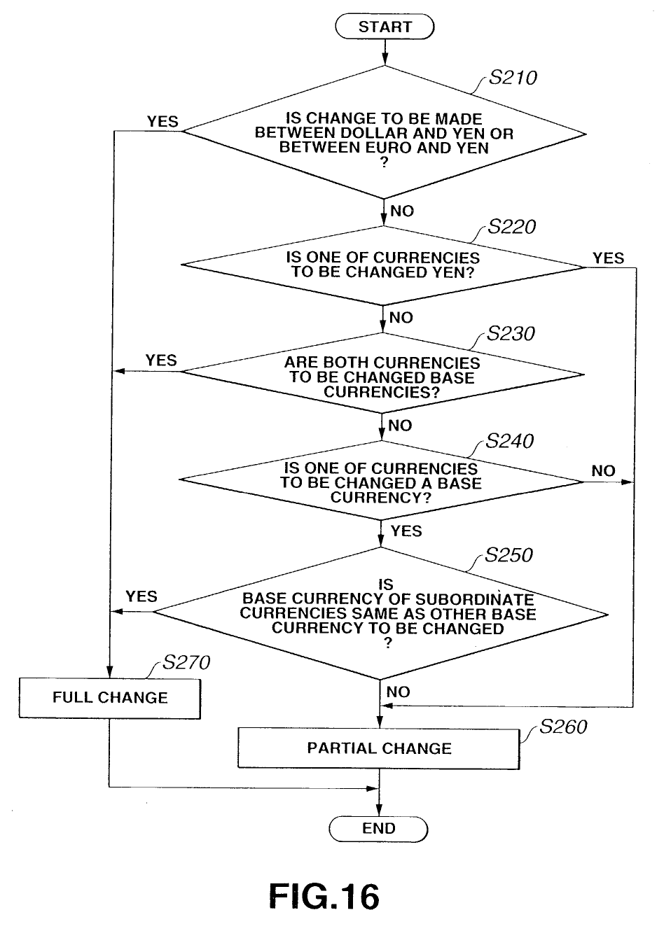

FIG. 16 shows a flow of operations made for determining whether a partial change (indirect conversion) of a currency is to be done.

The rate calculation/fund conversionunit 29 in FIG. 14 determines, based on the currency change data 30 stored in the currency change data storage unit 28, that is, the currency change data 30 and conversion currency data 32, sent from the companies 107a, 107b, . . . , whether the partial change (indirect conversion) is to be applied.

First, when the conversion currencies recorded in the conversion currency data 32 are dollar and yen, Euro and yen, and pound and yen (YES in step S210), the rate calculation/fund conversionunit 29 goes to step S270 where the conversion is made directly between a combination of currencies. For example, although pound is the subordinate currency of Euro, yen and pound, if applicable, may be converted directly between them correspondingly to the actual banking services.

Next, when the conversion currencies recorded in the conversion currency data 32 are not any of dollar and yen, Euro and yen, and pound and yen (NO in step S210), the rate calculation/fund conversionunit 29 determines whether one of the currencies to be converted between them is yen. When the one of the currencies is yen (YES in step S220), the rate calculation/fund conversionunit 29 goes to step S260 where a partial change (indirect conversion) will be done. Also, when both the currencies to be converted between them are not yen (NO in step S220), the rate calculation/fund conversionunit 29 goes to step S230 where it will determine whether both the conversion currencies are base currencies. When both the conversion currencies are base currencies (YES in step S230), the rate calculation/fund conversionunit 29 goes to step S270 where it will make a full change (direct conversion). Also, when both the conversion currencies are not any base currencies (NO in step S230), the rate calculation/fund conversionunit 29 goes to step S240 where it will determine whether one of the conversion currencies is a base currency.

When neither of the conversion currencies is any base currency (NO in step S240), the rate calculation/fund conversionunit 29 goes to step S260 where it will make a partial change (indirect conversion). Also, when one of the conversion currencies is a base currency (YES in step S240), the rate calculation/fund conversionunit 29 goes to step S250 where it will determine whether the base currency of a subordinate currency being one of the conversion currencies is the same as the base currency of the conversion currencies in consideration.

When the base currency of the subordinate currency is the same as the base currency of the conversion currencies (YES in step S250), the rate calculation/fund conversionunit 29 goes to step S270 where it will make a full change (direct conversion). Also, when the base currency of the subordinate currency is difference from the base currency of the conversion currencies (NO in step S250), the rate calculation/fund conversionunit 29 goes to step S260 where it will make a partial change (indirect change).

Thus, by grouping the conversion currencies into base currencies and subordinate ones belonging to the base currencies, it is possible to reduce the number of combinations of currencies to be hedged, that is, the number of currency pairs and thus make the currency change services more efficient and smooth.

Also, the submission of information on future in-payment and out-payment to the banking system 102 will allow the latter to make a netting as above.

Also, a profit return can be provided to not only the group companies but customers of a general bank having the banking system 102 installed therein.

Note that although in the variant having been described in the foregoing, yen, dollar and Euro are taken as the base currencies while the other currencies are taken as subordinate currencies, the present invention is not limited to the above but the base currencies may freely be set and also the currencies subordinate to such base currencies may freely be set.

Industrial Applicability

According to the present invention, since funds of companies included in a company group are collectively managed by one account for each currency unit, inter-company settlement is done by updating data in the received deposits table in which funds deposited from the companies are recorded in a data base without moving the funds in the account. Thus, it is possible to minimize the number of steps to be dome for a settlement between companies in the group. Also, in case multiple currencies are involved in the settlement as in case the settlement between the companies is done by changing a fund in yens to a money in dollars for example, it is possible to prevent an exposure of foreign exchange (a fund is exposed to an exchange risk).

Also, to avoid any foreign exchange risk, the funds of the group companies are collectively hedged, so that the financial control on each group company can be done even without any professional knowledge and many experiences.

Also, when a group company needs a conversion of its fund from one currency to another, a company rate set by a managing company entrusted to deal the funds of the group companies is selected, so that the group company will not be influenced by any exchange market fluctuations.

Also, when the group company has selected a premium rate whose convertible ratio of currency is lower than that of a company rate and if a market rate or hedged rate, at the time of currency change, is lower in convertible ratio than the premium rate, the group company can have a return of at least a part of an exchange profit. Thus, each group company can enjoy very much the merit of participating in the-funds concentration system, which in turn will be an incentive to encourage other group companies to take part in the funds concentration system.

Further, in case many kinds of currency pairs have to be hedged against exchange risk, the present invention allows to minimize the number of currency pairs to be hedged.

Moreover, the present invention allows to make a netting while making currency change with many kinds of currency units.

1. A funds concentration system for pooling funds in different currency units of each of companies belonging to a group in a single funds concentration account for centralized management of the funds, the system comprising:
means for acquiring information on in-payment of a fund paid into the funds concentration account;
means for acquiring information on out-payment of a fund paid from the funds concentration account by a member company of the company group;
a received deposits table having stored in a section thereof a breakdown of the fund balance on the funds concentration account for each of the companies, and in another section a breakdown of the fund balance in each of multiple currency units, if applicable;
means for acquiring information on an intra-group settlement when one of the companies in the group clears up an obligation by paying funds to any other company in the group;
means for calculating an applicable rate and converting, at the rate, an amount in a currency unit of a fund pooled on the funds concentration account into an amount in any other currency unit; and
means for updating the balance stored in each section of the received deposits table;
the balance updating means operating to:
increase the balance in a predetermined section of the received deposits table according to in-payment information acquired by the in-payment information acquiring means;
decrease the balance in a predetermined section of the received deposits table according to the out-payment information acquired by the out-payment information acquiring means;
move a predetermined amount of money from the balance in a section of the received deposits table for a payer company to the balance in a section of the table for a payee company; and
update the balance according to the change of the balance recorded in the received deposits table from a one before conversion of the currency unit to a one after the currency-unit conversion, in case the amount in a currency unit of the fund recorded in the received deposits table has been converted, by calculation, into any other currency unit by the rate calculating/fund converting means.

2. An exchange dealing apparatus, comprising:
means for acquiring a currency unit of a fund going to be converted in currency unit;
means for acquiring a currency unit of the fund having been converted in currency unit;
means for acquiring a to-be-converted fund amount in the pre-conversion currency unit;
means for acquiring a date on which the fund is to be converted in currency unit;
means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;
means for acquiring a conversion rate at which the pre-conversion currency unit a company desiring to convert its fund has selected is converted into the post-conversion currency unit; and
means for acquiring an exchange rate in the financial market on the date acquired by the date acquiring means;
the currency unit converting means functioning to:
convert the fund amount acquired by the to-be-converted fund amount acquiring means at the conversion rate from an amount in the pre-conversion currency unit into a one in the post-conversion currency unit, when the fund amount converted in currency unit at the conversion rate acquired by the conversion rate acquiring means is larger than that converted in currency unit at the exchange rate acquired by the exchange rate acquiring means; or
add at least a constant proportion of a difference between the exchange rate and conversion rate to the conversion rate and convert the fund amount acquired by the to-be-converted fund amount acquiring means at the resulted fate from an amount in the pre-conversion currency unit into a one in the post-conversion currency unit, when the fund amount converted in currency unit at the conversion rate acquired by the conversion rate acquiring means is smaller than that converted in currency unit at the exchange rate acquired by the exchange rate acquiring means.

3. An exchange dealing apparatus, comprising:
means for acquiring a currency unit of a fund going to be converted in currency unit;
means for acquiring a currency unit of the fund having been converted in currency unit;
means for acquiring a to-be-converted fund amount in the pre-conversion currency unit;
means for acquiring a date on which the fund is to be converted in currency unit;
means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;
means for acquiring a conversion rate at which the pre-conversion currency unit a company desiring to convert its fund has selected is converted into the post-conversion currency unit; and
means for acquiring an exchange rate in the financial market on the date acquired by the date acquiring means;
the currency unit converting means functioning to:
convert the fund amount acquired by the to-be-converted fund amount acquiring means from an amount in the pre-conversion currency unit into a one in the post-conversion currency unit at the conversion rate, when the fund amount converted in currency unit at the conversion rate acquired by the conversion rate acquiring means is larger than that converted in currency unit at the exchange rate acquired by the exchange rate acquiring means; or
convert the fund amount acquired by the to-be-converted fund amount acquiring means at the conversion rate from an amount in the pre-conversion currency unit into a one in the post-conversion currency unit, and then add at least a constant proportion of a difference between the fund amounts converted in currency unit at the exchange rate and conversion rate, respectively, to the fund amount after converted in currency unit, when the fund amount converted in currency unit at the conversion rate acquired by the conversion rate acquiring means is smaller than that converted in currency unit at the exchange rate acquired by the exchange rate acquiring means.

4. An exchange dealing apparatus, comprising:
means for acquiring a currency unit of a fund going to be converted in currency unit;
means for acquiring a currency unit of the fund having been converted in currency unit;
means for acquiring a to-be-converted fund amount in the pre-conversion currency unit;
means for acquiring a date on which the fund is to be converted in currency unit;
means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;
means for acquiring either a first rate at which the pre-conversion currency unit a company desiring to convert its fund has selected is converted into the post-conversion currency unit or a second rate with which the fund amount converted in currency unit is smaller than that converted in currency unit at the first rate; and
means for acquiring an exchange rate in the financial market on the date acquired by the date acquiring means;
the currency unit converting means functioning to:
convert the fund amount acquired by the to-be-converted fund amount acquiring means at the first rate from an amount in the pre-conversion currency unit into a one in the post-conversion currency unit, when the first rate is acquired by the rate acquiring means;
convert the fund amount acquired by the to-be-converted fund amount acquiring means at the second rate from an amount in the pre-conversion currency unit into a one in the post-conversion currency unit, when the second rate is acquired by the rate acquiring means and the fund amount converted in currency unit at the second rate is larger than that converted in currency unit at the exchange rate acquired by the exchange rate acquiring means; or
add at least a constant proportion of a difference between the exchange rate and second rate to the second rate and convert the fund amount acquired by the to-be-converted fund amount acquiring means at the resulted rate from an amount in the pre-conversion currency unit into a one in the post-conversion currency unit, when the second rate is acquired by the rate acquiring means and the fund amount converted in currency unit at the second rate is smaller than that converted in currency unit at the exchange rate acquired by the exchange rate acquiring means.

5. An exchange dealing apparatus, comprising:
means for acquiring a currency unit of a fund going to be converted in currency unit;
means for acquiring a currency unit of the fund having been converted in currency unit;
means for acquiring a to-be-converted fund amount in the pre-conversion currency unit;
means for acquiring a date on which the fund is to be converted in currency unit;
means for converting the fund amount acquired by the to-be-converted fund amount acquiring means at a predetermined rate from an amount in the currency unit acquired by the pre-conversion currency unit acquiring means into a one in the currency unit acquired by the post-conversion currency unit acquiring means;
means for acquiring either a first rate at which the pre-conversion currency unit a company desiring to convert its fund has selected is converted into the post-conversion currency unit or a second rate with which the fund amount converted in currency unit is smaller than that converted in currency unit at the first rate; and
means for acquiring an exchange rate in the financial market on the date acquired by the date acquiring means;
the currency unit converting means functioning to:
convert the fund amount acquired by the to-be-converted fund amount acquiring means at the first rate from an amount in the pre-conversion currency unit into a one in the post-conversion currency unit, when the first rate is acquired by the rate acquiring means;
convert the fund amount acquired by the to-be-converted fund amount acquiring means at the second rate from an amount in the pre-conversion currency unit into a one in the post-conversion currency unit, when the second rate is acquired by the rate acquiring means and the fund amount converted in currency unit at the second rate is larger than that converted in currency unit at the exchange rate acquired by the exchange rate acquiring means; or
convert the fund amount acquired by the to-be-converted fund amount acquiring means at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the second rate is acquired by the rate acquiring means and the fund amount converted in currency unit at the second rate is smaller than that converted in currency unit at the exchange rate acquired by the exchange rate acquiring means.

6. The system of claim 1, wherein the rate calculating/fund converting means is made up of an exchange dealing apparatus as set forth in any of claims 2 to 5.

7. The apparatus of any one of claims 2 to 5, wherein the exchange rate acquired by the exchange rate acquiring means is a spot rate in the interbank dealings.

8. The apparatus of any one of claims 2 to 5, wherein the exchange rate acquired by the exchange rate acquiring means is a rate hedged by derivative dealings.

9. The apparatus of claim 4, 5, 7 or 8, wherein:
the first rate used in any of the aforementioned exchange dealing apparatuses may be a result of addition or subtraction, to or from a market rate, of a swap being a cost for dealing in futures or a result of subtraction of a predetermined service free from a result of addition or subtraction, to or from a market rate, of a swap being a cost for dealing in futures; and
the second rate may be a result of subtraction of a predetermined value from the first rate.

10. The apparatus of any one of claims 4, 5, 7 to 9, wherein the rate of downing from the first rate to the second rate is a function of a ratio used to return, to a company desiring to convert its fund, of a profit raised from a difference between the exchange rate acquired by the exchange rate acquiring means and the second rate, further comprising:
means for making, based on a predetermined model, such a calculation that an expected value of a difference between a profit and a return to the company will be zero.

11. The apparatus of claim 10, wherein the predetermined model is an optional pricing model.

12. An exchange dealing method, comprising:
a first step of acquiring a currency unit of a fund going to be converted in currency unit;
a second step of acquiring a currency unit of the fund having been converted in currency unit;
a third step of acquiring a to-be-converted fund amount in the pre-conversion currency unit;
a fourth step of acquiring a date on which the fund is to be converted in currency unit;
a fifth step of acquiring a conversion rate at which the pre-conversion currency unit a company desiring to convert its fund has selected is converted into the post-conversion currency unit;
a sixth step of acquiring an exchange rate in the financial market on the date acquired in the fourth step; and
a seventh step of converting the fund amount acquired in the third step at a predetermined rate from an amount in the currency unit acquired in the first step into a one in the currency unit acquired in the second step;
the conversion of currency unit in the seventh step being such that:
when the fund amount converted in currency unit at the conversion rate acquired in the fifth step is larger than that converted in currency unit at the exchange rate acquired in the sixth step, the fund amount acquired in the third step is converted at the conversion rate from an amount in the pre-conversion currency unit into a one in the post-conversion currency unit; or
when the fund amount converted in currency unit at the conversion rate acquired in the fifth step is smaller than that converted in currency unit at the exchange rate acquired in the sixth step, at least a constant proportion of a difference between the exchange rate and conversion rate is added to the conversion rate and the fund amount in the third step rate is converted at the resulted rate from an amount in the pre-conversion currency unit into a one in the post-conversion currency unit.

13. An exchange dealing method, comprising:
a first step of acquiring a currency unit of a fund going to be converted in currency unit;
a second step of acquiring a currency unit of the fund having been converted in currency unit;
a third step of acquiring a to-be-converted fund amount in the pre-conversion currency unit;
a fourth step of acquiring a date on which the fund is to be converted in currency unit;
a fifth step of acquiring a conversion rate at which the pre-conversion currency unit a company desiring to convert its fund has selected is converted into the post-conversion currency unit;
a sixth step of acquiring an exchange rate in the financial market on the date acquired in the fourth step; and
a seventh step of converting the fund amount acquired in the third step at a predetermined rate from an amount in the currency unit acquired first step into a one in the currency unit acquired in the second step;
the conversion of currency unit in the seventh step being such that:
when the fund amount converted in currency unit at the conversion rate acquired in the fifth step is larger than that converted in currency unit at the exchange rate acquired in the sixth step, the fund amount acquired in the third step is converted at the conversion rate from an amount in the pre-conversion currency unit into a one in the post-conversion currency unit; or
when the fund amount converted in currency unit at the conversion rate in the fifth step is smaller than that converted in currency unit at the exchange rate acquired in the sixth step, the fund amount acquired in the third step is converted at the conversion rate from an amount in the pre-conversion currency unit into a one in the post-conversion currency unit and then at least a constant proportion of a difference between the fund amounts converted in currency unit at the exchange rate and conversion rate, respectively, is added to the fund amount after converted in currency unit.

14. An exchange dealing method, comprising:
a first step of acquiring a currency unit of a fund going to be converted in currency unit;
a second step of acquiring a currency unit of the fund having been converted in currency unit;
a third step of acquiring a to-be-converted fund amount in the pre-conversion currency unit;
a fourth step of acquiring a date on which the fund is to be converted in currency unit;
a fifth step of acquiring either a first rate at which the pre-conversion currency unit a company desiring to convert its fund has selected is converted into the post-conversion currency unit or a second rate with which the fund amount converted in currency unit is smaller than that converted in currency unit at the first rate; and
a sixth step of acquiring an exchange rate in the financial market on the date acquired in the fourth step; and
a seventh step of converting the fund amount acquired in the third step at a predetermined rate from an amount in the currency unit acquired in the first step into a one in the currency unit acquired in the second step;
the conversion of currency unit in the seventh step being such that:
when the first rate is acquired in the fifth step, the fund amount acquired in the third step is converted at the first rate from an amount in the pre-conversion currency unit into a one in the post-conversion currency unit;
when the second rate is acquired in the fifth step and the fund amount converted in currency unit at the second rate is larger than that converted in currency unit at the exchange rate acquired in the sixth step, the fund amount acquired in the third step is converted at the second rate from an amount in the pre-conversion currency unit into a one in the post-conversion currency unit; or
when the second rate is selected in the fifth step and the fund amount converted in currency unit at the second rate is smaller than that converted in currency unit at the exchange rate acquired in the sixth step, at least a constant proportion of a difference between the exchange rate and second rate is added to the second rate and the fund amount acquired in the third step is converted at the resulted rate from an amount in the pre-conversion currency unit into a one in the post-conversion currency unit.

15. An exchange dealing method, comprising:
a first step of acquiring a currency unit of a fund going to be converted in currency unit;
a second step of acquiring a currency unit of the fund having been converted in currency unit;
a third step of acquiring a to-be-converted fund amount in the pre-conversion currency unit;
a fourth step of acquiring a date on which the fund is to be converted in currency unit;
a fifth step of acquiring either a first rate at which the pre-conversion currency unit a company desiring to convert its fund has selected is converted into the post-conversion currency unit or a second rate with which the fund amount converted in currency unit is smaller than that converted in currency unit at the first rate;
a sixth step of acquiring an exchange rate in the financial market on the date acquired in the fourth step; and
a seventh step of converting the fund amount acquired in the third step at a predetermined rate from an amount in the currency unit acquired in the first step into a one in the currency unit acquired in the second step;
the conversion of currency unit in the seventh step being such that:
when the first rate is acquired in the fifth step, the fund amount acquired in the third step is converted at the first rate from an amount in the pre-conversion currency unit into a one in the post-conversion currency unit;
when the second rate is acquired in the fifth step and the fund amount converted in currency unit at the second rate is larger than that converted in currency unit at the exchange rate acquired in the sixth step, the fund amount acquired in the third step is converted at the second rate from an amount in the pre-conversion currency unit into a one in the post-conversion currency unit; or
when the second rate is acquired in the fifth step and the fund amount converted in currency unit at the second rate is smaller than that converted in currency unit at the exchange rate acquired in the sixth step, the fund amount acquired in the third step is converted at the second rate from an amount in the pre-conversion currency unit into a one in the post-conversion currency unit and then at least a constant proportion of a difference between the fund amounts converted in currency unit at the exchange rate and second rate, respectively, is added to the fund amount after converted in currency unit.

16. A computer-readable recording medium having stored therein an exchange dealing program causing a computer to perform functions to:
acquire a currency unit of a fund going to be converted in currency unit;
acquire a currency unit of the fund having been converted in currency unit;
acquire a to-be-converted fund amount in the pre-conversion currency unit;
acquire a date on which the fund is to be converted in currency unit;
convert the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;
acquire a conversion rate at which the pre-conversion currency unit a company desiring to convert its fund has selected is converted into the post-conversion currency unit; and
acquire an exchange rate in the financial market on the date acquired by the date acquiring function;
the currency unit converting function being to:
convert the fund amount acquired by the to-be-converted fund amount acquiring function at the conversion rate from an amount in the pre-conversion currency unit into a one in the post-conversion currency unit, when the fund amount converted in currency unit at the conversion rate acquired by the conversion rate acquiring function is larger than that converted in currency unit at the exchange rate acquired by the exchange rate acquiring function; or
add at least a constant proportion of a difference between the exchange rate and conversion rate to the conversion rate and convert the fund amount acquired by the to-be-converted fund amount acquiring function at the resulted rate from an amount in the pre-conversion currency unit into a one in the post-conversion currency unit, when the fund amount converted in currency unit at the conversion rate acquired by the conversion rate acquiring function is smaller than that converted in currency unit at the exchange rate acquired by the exchange rate acquiring function.

17. A computer-readable recording medium having stored therein an exchange dealing program causing a computer to perform functions to:
acquire a currency unit of a fund going to be converted in currency unit;
acquire a currency unit of the fund having been converted in currency unit;
acquire a to-be-converted fund amount in the pre-conversion currency unit;
acquire a date on which the fund is to be converted in currency unit;
convert the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;
acquire a conversion rate at which the pre-conversion currency unit a company desiring to convert its fund has selected is converted into the post-conversion currency unit; and
acquire an exchange rate in the financial market on the date acquired by the date acquiring function;
the currency unit converting function being to:
convert the fund amount acquired by the to-be-converted fund amount acquiring function from an amount in the pre-conversion currency unit into a one in the post-conversion currency unit at the conversion rate, when the fund amount converted in currency unit at the conversion rate acquired by the conversion rate acquiring function is larger than that converted in currency unit at the exchange rate acquired by the exchange rate acquiring function; or
convert the fund amount acquired by the to-be-converted fund amount acquiring function at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the fund amount converted in currency unit at the conversion rate acquired by the conversion rate acquiring function is smaller than that converted in currency unit at the exchange rate acquired by the exchange rate acquiring function.

18. A computer-readable recording medium having stored therein an exchange dealing program causing a computer to perform functions to:
acquire a currency unit of a fund going to be converted in currency unit;
acquire a currency unit of the fund having been converted in currency unit;
acquire a to-be-converted fund amount in the pre-conversion currency unit;
acquire a date on which the fund is to be converted in currency unit;
convert the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;
acquire either a first rate at which the pre-conversion currency unit a company desiring to convert its fund has selected is converted into the post-conversion currency unit or a second rate with which the fund amount converted in currency unit is smaller than that converted in currency unit at the first rate; and
acquire an exchange rate in the financial market on the date acquired by the date acquiring function;
the currency unit converting function being to:
convert the fund amount acquired by the to-be-converted fund amount acquiring function at the first rate from an amount in the pre-conversion currency unit into a one in the post-conversion currency unit, when the first rate is acquired by the rate acquiring function;
convert the fund amount acquired by the to-be-converted fund amount acquiring function at the second rate from an amount in the pre-conversion currency unit into a one in the post-conversion currency unit, when the second rate is acquired by the rate acquiring function and the fund amount converted in currency unit at the second rate is larger than that converted in currency unit at the exchange rate acquired by the exchange rate acquiring function; or
add at least a constant proportion of a difference between the exchange rate and second rate to the second rate and convert the fund amount acquired by the to-be-converted fund amount acquiring function at the resulted rate from an amount in the pre-conversion currency unit into a one in the post-conversion currency unit, when the second rate is acquired by the rate acquiring function and the fund amount converted in currency unit at the second rate is smaller than that converted in currency unit at the exchange rate acquired by the exchange rate acquiring function.

19. A computer-readable recording medium having stored therein an exchange dealing program causing a computer to perform functions to:
acquire a currency unit of a fund going to be converted in currency unit;
acquire a currency unit of the fund having been converted in currency unit;
acquire a to-be-converted fund amount in the pre-conversion currency unit;
acquire a date on which the fund is to be converted in currency unit;
a function for converting the fund amount acquired by the to-be-converted fund amount acquiring function at a predetermined rate from an amount in the currency unit acquired by the pre-conversion currency unit acquiring function into a one in the currency unit acquired by the post-conversion currency unit acquiring function;
acquire either a first rate at which the pre-conversion currency unit a company desiring to convert its fund has selected is converted into the post-conversion currency unit or a second rate with which the fund amount converted in currency unit is smaller than that converted in currency unit at the first rate; and
acquire an exchange rate in the financial market on the date acquired by the date acquiring function;
the currency unit converting function being to:
convert the fund amount acquired by the to-be-converted fund amount acquiring function at the first rate from an amount in the pre-conversion currency unit into a one in the post-conversion currency unit, when the first rate is acquired by the rate acquiring function;
convert the fund amount acquired by the to-be-converted fund amount acquiring function at the second rate from an amount in the pre-conversion currency unit into a one in the post-conversion currency unit, when the second rate is acquired by the rate acquiring function and the fund amount converted in currency unit at the second rate is larger than that converted in currency unit at the exchange rate acquired by the exchange rate acquiring function; or
convert the fund amount acquired by the to-be-converted fund amount acquiring function at the conversion rate from an amount in the pre-conversion currency unit into a one in the post-conversion currency unit and then add at least a constant proportion of a difference between the fund amounts converted in currency unit at the exchange rate and conversion rate, respectively, to the fund amount after converted in currency unit, when the second rate is acquired by the rate acquiring function and the fund amount converted in currency unit at the second rate is smaller than that converted in currency unit at the exchange rate acquired by the exchange rate acquiring function.

20. A currency change server computer for providing a currency change service to a company upon request from the latter, the computer comprising:
means for receiving, from the company, a request for currency change of a money from a first currency unit to a second currency unit, which also specifies an amount of money to be converted in currency unit;
means for calculating an exchange rate set when the currency change request is received by the request receiving means and an amount of profit based on the conversion amount of money and coming from a difference between the first and second currency units with which the money has actually been converted in currency unit; and
means for returning, to the company, an amount of money calculated based on the profit amount-and conversion money amount.

21. The computer of claim 20, further comprising means for converting a money at any one of the exchange rate set when the currency change request is received by the request receiving means and an exchange rate which is when the currency change is made, whichever will provide a larger amount of money converted in currency unit.

22. The computer of claim 20, further comprising a partial exchanging means for converting a money from an amount in a first currency unit into a one in a second currency unit via currency change between the one in the first currency unit and a one in a third currency unit.

23. A currency change method of providing a currency change service to a company upon request from the latter, the method comprising:
a first step of receiving, from the company, a request for currency change of a money from a first currency unit to a second currency unit, which also specifies an amount of money to be converted in currency unit;
a second step of calculating an exchange rate set when the currency change request is received by the request receiving means and an amount of profit based on the conversion amount of money and coming from a difference between the first and second currency units with which the money has actually been converted in currency unit; and
a third step of returning, to the company, an amount of money calculated based on the profit amount and conversion money amount.

24. A currency change server program for providing a currency change service to a company upon request from the latter, the program causing a currency change server computer to perform functions to:
receive, from the company, a request for currency change of a money from a first currency unit to a second currency unit, which also specifies an amount of money to be converted in currency unit;
calculate an exchange rate set when the currency change request is received by the request receiving function and an amount of profit based on the conversion amount of money and coming from a difference between the first and second currency units with which the money has actually been converted in currency unit; and
return, to the company, an amount of money calculated based on the profit amount and conversion money amount.

25. A currency change client computer for making a request to a managing company of a group of companies for providing a currency change service, the computer comprising:
means for making, to the currency change server computer at the managing company, a request for currency change of a money from a first currency unit to a second currency unit, which also specifies an amount of the money to be converted in currency unit; and
means for receiving, from the currency change server computer, an amount of money based on the profit amount calculated based on a difference between an exchange rate set when the currency change request has been made by the request making means and a one at which the money has been converted.

26. A method for making a request to a managing company of a group of companies for providing a currency change service, the method comprising:
a first step of making, to the currency change server computer at the managing company, a request for currency change of a money from a first currency unit to a second currency unit, which also specifies an amount of the money to be converted in currency unit; and
a second step of receiving, from the currency change server computer, an amount of money based on the profit amount calculated based on a difference between an exchange rate set when the currency change request has been made in the first step and a one at which the money has been converted.

27. A currency change request client program for making a request to a managing company of a group of companies for providing a currency change service, the program causing a currency change request client computer to perform functions to:
make, to the currency change server computer at the managing company, a request for currency change of a money from a first currency unit to a second currency unit, which also specifies an amount of the money to be converted in currency unit; and
receive, from the currency change server computer, an amount of money based on the profit amount calculated based on a difference between an exchange rate set when the currency change request has been made by the request making function and a one at which the money has been converted.

28. A currency change server computer for providing a currency change service to a company upon request from the latter, the computer comprising:
means for identifying a currency unit pair to hedge a money in consideration against exchange risk;
a currency change request acquiring means for acquiring, from the company, a first conversion-source currency unit, second conversion-destination currency unit and an amount of money to be converted in currency unit;
means for determining whether the pair of first and second currency units acquired by the exchange request acquiring means is included in the currency pair identified by the identifying means; and
means for converting the money from an amount in the first currency unit to a one in the second currency unit when it is determined by the determining means that the pair of the first and second currency units is included in the currency unit pair identified by the identifying means; or from an amount in the first currency unit into a one in the second currency unit via currency change between the currency units included in the currency unit pair identified by the identifying means when it is determined by the determining means that the pair of the first and second currency units is not included in the currency unit pair identified by the identifying means.

29. The computer of claim 28, further comprising a profit returning means for returning, to the company, a part of a profit from a difference between an exchange rate set when the company has made the currency change request and an exchange rate used for the currency change between the currency rates in pair.

30. The computer of claim 28, wherein the identifying means further includes:
means for sorting the currency unit into a base currency unit or a subordinate currency unit;
means for relating each of subordinate currency units sorted by the sorting means with any one of base currency units; and
means for generating a currency pair from two of the base currency units sorted by the sorting means or from the base currency unit and subordinate currency units, related with each other by the relating means.

31. A currency change method for providing a currency change service to a company upon request from the latter, the method comprising:
a first step of identifying a currency unit pair to hedge against exchange risk;
a second step of acquiring, from the company, a first conversion-source currency unit, second conversion-destination currency unit and an amount of money to be converted in currency unit;
a third step of determining whether the pair of first and second currency units acquired in the second step is included in the currency pair identified by the identifying means; and
a fourth step of converting the money from an amount in the first currency unit into a one in the second currency unit according to a determined made in the third step;
the fourth step being such that the money is converted from an amount in the first currency unit into a one in the second currency unit when it is determined in the third step that the pair of the first and second currency units is included in the currency unit pair identified in the first step, or from an amount in the from an amount in the first currency unit to a one in the second currency unit via currency change between the currency units included in the currency unit pair identified in the first step when it is determined in the third step that the pair of the first and second currency units is not included in the currency unit pair identified in the first step.

32. The method of claim 31, wherein the first step includes:
a 1a-th step of sorting the currency unit into a base currency unit or subordinate currency unit;
a 1b-th step of relating each subordinate currency unit sorted in the 1a-th step with any one of base currency units; and
a 1c-th step of generating a currency pair from two base currency units sorted in the 1a-th step or from the base currency unit and subordinate currency unit, related with each other in the 1b-th step.

33. A currency change server program for providing a currency change service to a company upon request from the latter, the program causing a currency change server computer to perform functions to:
identify a currency unit pair to hedge against exchange risk;
acquire, from the company, a first conversion-source currency unit, second conversion-destination currency unit and an amount of money to be converted in currency unit;
determine whether the pair of first and second currency units acquired by the currency change request acquiring function is included in the currency pair identified by the identifying function; and
convert the money from an amount in the first currency unit to a one in the second currency unit when it is determined by the determining function that the pair of the first and second currency units is included in the currency unit pair identified by the identifying function; or from an amount in the first currency unit to a one in the second currency unit via currency change between the currency units included in the currency unit pair identified by the identifying function when it is determined by the determining function that the pair of the first and second currency units is not included in the currency unit pair identified by the identifying function.

34. The program of claim 33, wherein the above identifying function includes functions to:
sort the currency unit into a base currency unit or subordinate currency unit;
relate each subordinate currency unit sorted by the sorting function with any one of base currency units; and
generate a currency pair from two base currency units sorted by the sorting function or from the base currency unit and subordinate currency unit, related with each other by the relating function.

35. A netting apparatus, comprising:
means for recording the balance on the account of each customer company in each currency unit;
an in-payment information acquiring means for acquiring an in-payment date, in-payment currency unit and in-payment amount of a fund transferred into the account of the customer company; and
an out-payment information acquiring means for acquiring an out-payment date, out-payment currency unit, and out-payment amount of a fund paid from the account of the customer company into the account of any other company, and a payee company;
the recording means making a netting by moving at least a part of the amount of in-payment into the account of the customer company to the balance on the account of the other customer company when the payee company acquired by the in-payment information acquiring means is an other customer company, the in-payment date acquired by the in-payment information acquiring means is the same as the out-payment date acquired by the out-payment information acquiring means and the in-payment currency unit acquired by the in-payment information acquiring means is the same as the out-payment currency unit acquired by the out-payment information acquiring means.

36. A netting method, comprising:
a first step of recording the balance on the account of each customer company in each currency unit;
a second step of acquiring an in-payment date, in-payment currency unit and in-payment amount of a fund transferred into the account of the customer company;
a third step of acquiring an out-payment date, out-payment currency unit, and out-payment amount of a fund paid from the account of the customer company into the account of any other company, and a payee company; and
a fourth step of making a netting by moving at least a part of the amount of in-payment into the account of the customer company to the balance on the account of the other customer company when the payee company acquired in the third step is an other customer company, the in-payment date acquired in the second step is the same as the out-payment date acquired in the third step and the in-payment currency unit acquired in the second step is the same as the out-payment currency unit acquired in the third step.

37. A netting program causing a computer to perform functions to:
record the balance on the account of each customer company in each currency unit;
acquire an in-payment date, in-payment currency unit and in-payment amount of a fund transferred into the account of the customer company; and
acquire an out-payment date, out-payment currency unit, and out-payment amount of a fund paid from the account of the customer company into the account of any other company, and a payee company;
make a netting by moving at least a part of the amount of in-payment into the account of the customer company to the balance on the account of the other customer company when the payee company acquired by the in-payment information acquiring means is an other customer company, the in-payment date acquired by the in-payment information acquiring means is the same as the out-payment date acquired by the out-payment information acquiring means and the in-payment currency unit acquired by the in-payment information acquiring means is the same as the out-payment currency unit acquired by the out-payment information acquiring means.
